(19) United States
(12) Patent Application Publication
(10) Pub. No.: US 2023/0256879 A1
(43) Pub. Date: Aug. 17, 2023

(54) SEAT SYSTEMS AND METHODS FOR WATERCRAFT

(71) Applicant: EK Projects, LLC, Burlington, WA (US)

(72) Inventors: Jeffrey A. Weber, Minneapolis, MN (US); Jason Van Putten Holt, Minneapolis, MN (US); Shawn Sheridan Monitor, Robbinsdale, MN (US)

(73) Assignee: EK Projects, LLC, Burlington, WA (US)

(21) Appl. No.: 18/157,637

(22) Filed: Jan. 20, 2023

Related U.S. Application Data
(60) Provisional application No. 63/266,971, filed on Jan. 20, 2022.

(51) Int. Cl. B60N 2/90; B60N 2/24; B63B 34/26; B60N 2/22

(52) U.S. Cl. CPC B60N 2/986; B60N 2/24; B63B 34/26; B60N 2/22; B63B 2029/043

(57) ABSTRACT

A seat system for a watercraft defining a support surface, the seat system comprising a seat frame, a seat cover supported by the seat frame, at least one first mounting assembly, and at least one second mounting assembly. The at least one first mounting assembly is secured to the support surface. The at least one second mounting assembly is secured to the support surface. The seat frame is slid horizontally to engage one of the first mounting assemblies and is pivoted such that the seat frame moves downward to engage the second mounting assembly.

### RELATED APPLICATIONS

This application (Attorney's Ref. No. P220355) claims benefit of U.S. Provisional Application Ser. No. 63/266,971, filed on Jan. 20, 2022, currently pending. The contents of all related applications are incorporated herein by reference.

### TECHNICAL FIELD

The present invention relates to watercraft and, more specifically, to seat systems and methods that are adapted to support a user in a watercraft such as a kayak, canoe, or paddleboard.

### SUMMARY

The present invention may be embodied as a seat system for a watercraft defining a support surface. The seat system comprises a seat frame, a seat cover supported by the seat frame, at least one first mounting assembly, and at least one second mounting assembly. The at least one first mounting assembly is secured to the support surface. The at least one second mounting assembly is secured to the support surface. The seat frame is slid horizontally to engage one of the first mounting assemblies. The seat frame is pivoted such that the seat frame moves downward to engage the second mounting assembly.

The present invention may also be embodied as a seat system for a watercraft defining a support surface in which the seat system comprises a seat frame, a seat cover supported by the seat frame, a mounting assembly for securing the seat frame to the support surface, and first and second hip assemblies supported by the seat frame. At least one of the first and second hip assemblies is laterally adjustable relative to the seat frame.

The present invention may also be embodied as a seat system for a watercraft defining a support surface in which the seat system comprises a seat frame, a seat cover supported by the seat frame, a mounting assembly for securing the seat frame to the support surface, and a back support. The back support comprises an upright assembly supported by the seat frame, a back support assembly supported by the upright assembly for movement relative to the seat frame, and a guide member. The guide member is supported to engage the upright assembly and the back support assembly such that the guide member supports the back support assembly in at least upper and lower vertical positions relative to the upright assembly.

### BRIEF DESCRIPTION OF THE DRAWINGS

FIG. 1 is a front perspective view of an example watercraft incorporating a first example seat system of the present invention;

FIG. 2 is a partly exploded front perspective view of the first example seat system of the present invention;

FIG. 3 is a partly exploded rear perspective view of the first example seat system of the present invention;

FIG. 4 is front elevation view of the first example seat system of the present invention;

FIG. 5 is bottom plan view of the first example seat system of the present invention;

FIG. 6 is a section view taken along lines 6-6 in FIG. 5;

FIG. 7 is a top plan view of the first example seat system of the present invention;

FIG. 8 is a section view taken along lines 8-8 in FIG. 7;

FIGS. 9 and 10 illustrate assembly/removal of a pommel to/from to a seat frame;

FIG. 11 is a section view taken along lines 11-11 in FIG. 7 illustrating a first example back support system of the first example seat system;

FIG. 12 is an exploded perspective view of an adjustable hip assembly of the first example seat system;

FIG. 13 is a section view taken along lines 13-13 in FIG. 7 showing the adjustable hip assembly in a first configuration;

FIG. 14 is a section view taken along lines 14-14 in FIG. 7 showing the adjustable hip assembly in the first configuration;

FIG. 15 is a section view similar to FIG. 13 illustrating the adjustable hip assembly in a second configuration;

FIG. 16 is a section view similar to FIG. 14 illustrating the adjustable hip assembly in the second configuration;

FIG. 17 is a section view taken along lines 17-17 in FIG. 7 illustrating the adjustable hip assembly in an uncompressed configuration;

FIG. 18 is a section view similar to FIG. 17 illustrating the adjustable hip assembly in a compressed configuration;

FIG. 19 is a perspective view illustrating an optional leg system and second example back support system that may be use with the first example seat system of the present invention;

FIG. 20 is a front elevation view illustrating the second back support system;

FIG. 21 is an exploded view of the second example back support system;

FIG. 22 is a section view taken along lines 22-22 in FIG. 20;

FIG. 23 is a partial exploded section view of a portion of FIG. 22;

FIG. 24 is a section view taken along lines 24-24 in FIG. 25, illustrating the second example back support system in a lowermost configuration;

FIG. 25 is a section view taken along lines 25-25 in FIG. 24;

FIG. 26 is a section view taken along lines 26-26 in FIG. 24;

FIG. 27 is a section view taken along lines 27-27 in FIG. 24;

FIG. 28 is a section view taken along lines 28-28 in FIG. 25, illustrating the second example back support system in a lowermost configuration;

FIG. 29 is a section view taken along lines 29-29 in FIG. 25, illustrating the second example back support system in a lowermost configuration;

FIG. 30A is a section view similar to FIG. 24 illustrating displacement of the second example back support system out of the lowermost configuration;

FIG. 30B is a section view similar to FIG. 28 illustrating displacement of the second example back support system out of the lowermost configuration;

FIG. 30C is a section view similar to FIG. 29 illustrating displacement of the second example back support system out of the lowermost configuration;

FIG. 31 is a section view similar to FIG. 24 illustrating the second example back support system in a first intermediate configuration;

FIG. 32 is a section view similar to FIG. 24 illustrating the second example back support system in an uppermost configuration;

FIG. 33A is a section view similar to FIG. 24 illustrating a first step of a process of displacing the second example back support system from the uppermost configuration to the lowermost configuration;

FIG. 33B is a section view similar to FIG. 28 illustrating the first step of the process of displacing the second example back support system from the uppermost configuration to the lowermost configuration;

FIG. 33C is a section view similar to FIG. 29 illustrating the first step of the process of displacing the second example back support system from the uppermost configuration to the lowermost configuration;

FIG. 34A is a section view similar to FIG. 24 illustrating a second step of a process of displacing the second example back support system from the uppermost configuration to the lowermost configuration;

FIG. 34B is a section view similar to FIG. 28 illustrating the second step of the process of displacing the second example back support system from the uppermost configuration to the lowermost configuration;

FIG. 34C is a section view similar to FIG. 29 illustrating the second step of the process of displacing the second example back support system from the uppermost configuration to the lowermost configuration;

FIG. 35A is a section view similar to FIG. 24 illustrating a third step of a process of displacing the second example back support system from the uppermost configuration to the lowermost configuration;

FIG. 35B is a section view similar to FIG. 28 illustrating the third step of the process of displacing the second example back support system from the uppermost configuration to the lowermost configuration;

FIG. 35C is a section view similar to FIG. 29 illustrating the third step of the process of displacing the second example back support system from the uppermost configuration to the lowermost configuration;

FIG. 36A is a section view similar to FIG. 24 illustrating a fourth step of a process of displacing the second example back support system from the uppermost configuration to the lowermost configuration;

FIG. 36B is a section view similar to FIG. 28 illustrating the fourth step of the process of displacing the second example back support system from the uppermost configuration to the lowermost configuration;

FIG. 36C is a section view similar to FIG. 29 illustrating the fourth step of the process of displacing the second example back support system from the uppermost configuration to the lowermost configuration;

FIG. 37A is a section view similar to FIG. 24 illustrating a fifth step of a process of displacing the second example back support system from the uppermost configuration to the lowermost configuration;

FIG. 37B is a section view similar to FIG. 28 illustrating the fifth step of the process of displacing the second example back support system from the uppermost configuration to the lowermost configuration;

FIG. 37C is a section view similar to FIG. 29 illustrating the fifth step of the process of displacing the second example back support system from the uppermost configuration to the lowermost configuration;

FIG. 38 is a section view similar to FIG. 24 illustrating a final step of the process of displacing the second example back support system into the lowermost configuration;

FIG. 39 is a side elevation view depicting a first example strap system that may be used with the second example seat system 420 as described above;

FIG. 40 is a side elevation view depicting the first example strap system being used to adjust tension on the back support assembly;

FIG. 41 is a front elevation view depicting the first example strap system;

FIGS. 42 and 43 are front elevation views illustrating engagement of a back engaging portion and a back opening formed in the back support assembly;

FIGS. 44 and 45 are bottom plan views illustrating engagement of a support anchor and an anchor structure of the seat frame;

FIGS. 46 and 47 are front elevation partial section views illustrating the support anchor as supported by the anchor structure of the seat frame and engagement of the anchor blocks of the support straps with the with support anchors;

FIGS. 48-51 are top plan partial section views illustrating engagement of the anchor blocks of the support straps with the with support anchors;

FIG. 52 is a side elevation view of the second example seat system being used with a first example leg system of the present invention;

FIG. 53 is a front elevation view of the second example seat system being used with the first example leg system; and

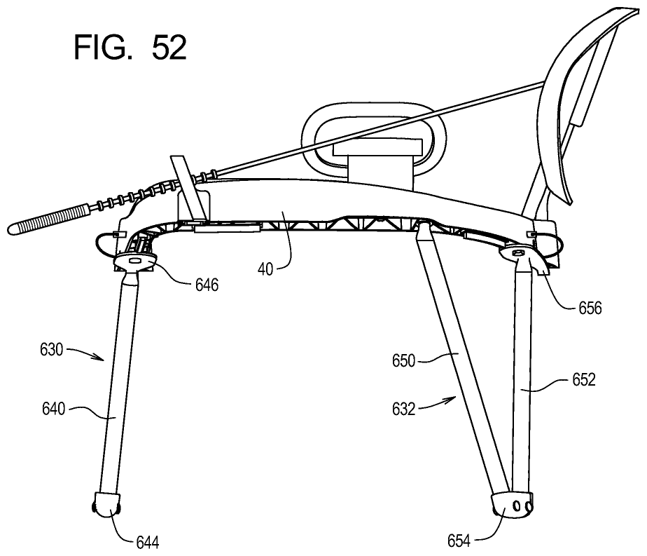

FIG. 52 is a bottom plan view of the second example seat system being used with the first example leg system.

### DETAILED DESCRIPTION

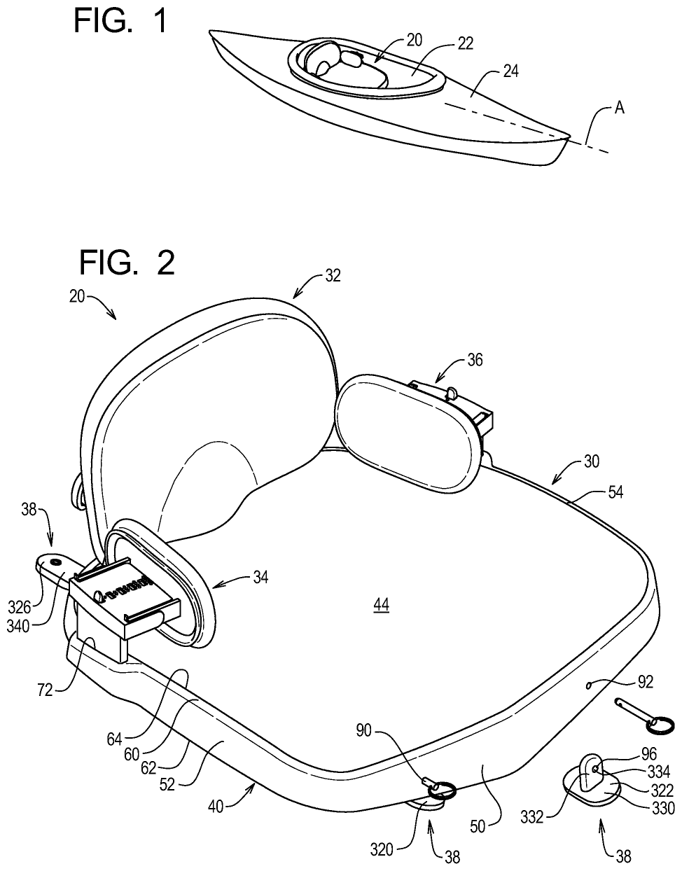

FIGS. 1 and 2 of the drawing depicts a first example seat system 20 constructed in accordance with, and embodying, the principles of the present invention. The first example seat system 20 is adapted to be used in a cockpit 22 of a watercraft 24 such as a kayak.

The first example seat system 20 comprises a seat assembly 30, a back support assembly 32, a first hip brace assembly 34, a second hip brace assembly 36, and a cleat system 38. A user (not shown for clarity) sits on the seat assembly 30 such that the back support assembly 32 engages the user's lower back and the first and second hip brace assemblies 34 and 36 engage the user's left and right hips, respectively. The cleat system allows the example seat system 20 to be detachably attached within the cockpit 22 of the kayak 24.

The example seat assembly 30 provides a lightweight, flexible seating surface for the user while using the kayak 24. The example back support assembly 32 provides support for the user's back while the user operates the kayak 24. The example back support assembly 32 is resiliently supported from the example seat assembly 30 to enhance comfort for the user. The example first and second hip brace assemblies 34 and 36 are laterally movable towards and away from the user. The hip brace assemblies 34 and 36 can thus be adjusted to snugly engage the user's hips to accommodate users of different sizes and shapes. The example cleat system 38 allows the first example seat system 20 to be installed in a watercraft as a retrofit seat system and further allows the example seat system 20 to be removed when the watercraft 24 is transported and/or stored.

The construction and operation of the first example seat system 20 will now be described in further detail. In the following discussion, the terms “upper”, “lower”, “vertical”, and “horizontal” when used in reference to the example watercraft 24 when in an upright configuration during normal use. The terms “forward” or “front” refer to a direction or location toward a bow of the watercraft 24, while the terms “rearward” or “back” refer to a direction or location toward a stern of the watercraft 24. The term “lateral” refers to either direction orthogonal to a longitudinal axis A of the watercraft 24.

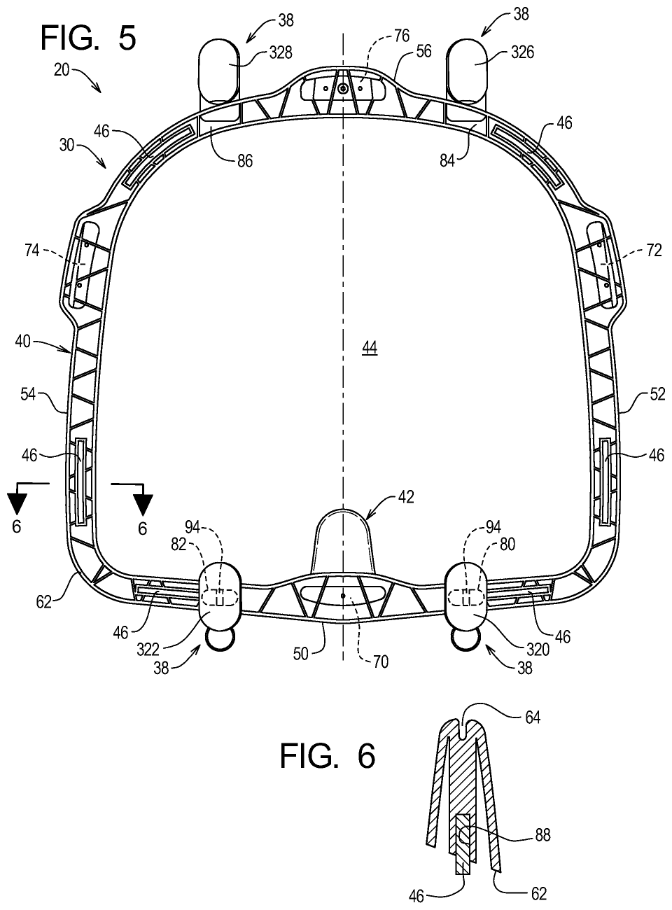

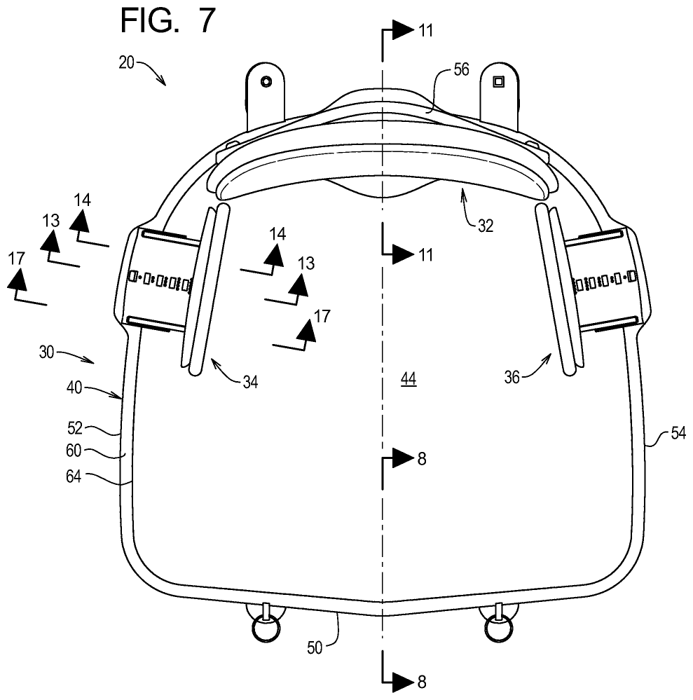

FIGS. 5-11 illustrate that the example seat assembly 30 comprises a seat frame 40, a pommel 42, a seat cover 44, and, optionally, one or more foot members 46. The example seat frame 40 is continuous structure comprising a front portion 50, a first side portion 52, a second side portion 54, and a rear portion 56. The example seat frame 40 defines an upper edge 60 and a lower edge 62.

An upper edge groove 64 extends around the upper edge 60 of the example seat frame 40. The example edge groove 64 extends entirely around the example seat frame 40, but the example edge groove 64 may extend only partly around the seat frame 40.

A pommel pocket 70 is formed in the upper edge 60 on the front portion 50. The pommel pocket 70 is sized and dimensioned to receive a portion of the pommel 42.

A first hip pocket 72 is formed in the upper edge 60 on the first side portion 52, and a second hip pocket 74 is formed in the upper edge 60 on the second side portion 54. The first and second hip pockets 72 and 74 are sized and dimensioned to receive portions of the first and second hip brace assemblies 34 and 36, respectively.

A back pocket 76 is formed on the upper edge 60 on the rear portion 56. The example back pocket 76 is sized and dimensioned to received a portion of the back support assembly 32.

First and second front cleat pockets 80 and 82 are formed in the front portion 50, and first and second rear cleat pockets 84 and 86 are formed in the rear portion 56. The example front cleat pockets 80 and 82 are substantially vertical during normal use of the example seat system 20. The example rear cleat pockets 84 and 86 are substantially horizontal during normal use of the example seat system 20.

For each of the optional foot members 46, a foot pocket 88 is formed in the lower edge 62 of the seat frame 40. The example foot pocket(s) 88 is(are) sized and dimensioned to receive a portion of the foot member(s) 46 such that a portion of the foot member(s) 46 extends bound the lower edge 62 of the seat frame 40. The example foot pocket(s) 88 are substantially vertical during normal use of the example seat system 20.

The front portion 50 of the example seat frame 40 further defines first and second pin openings 90 and 92. The pin openings 90 and 92 are extend along the longitudinal axis A of the watercraft 24 such that the pin openings 90 and 92 intersect the first and second pin openings 94 and 96, in the cleat assembly.

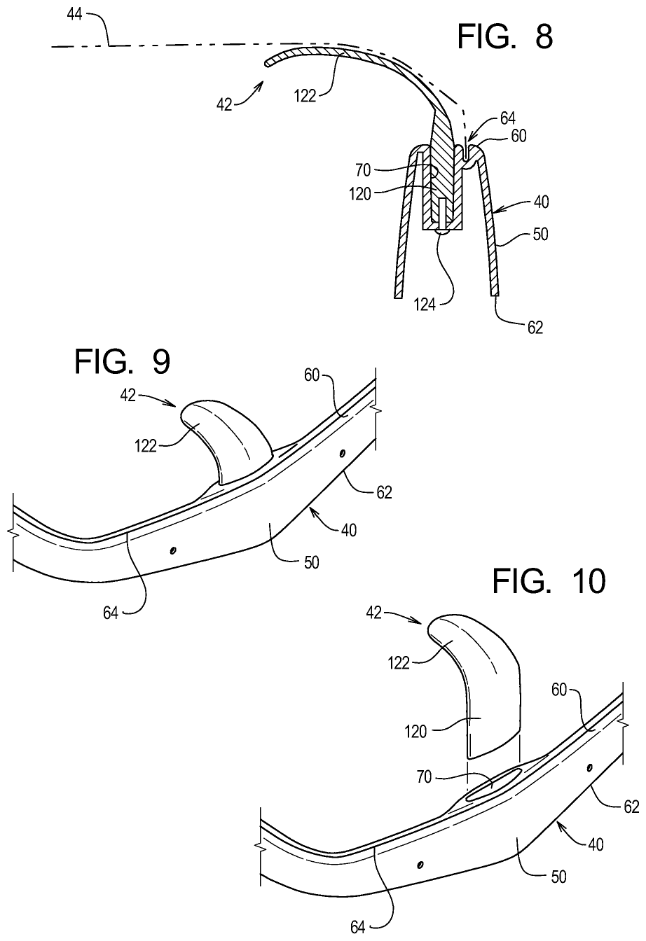

FIGS. 8-10 illustrate that the example pommel 42 defines a base portion 120 and a cover support portion 122 and that the example base portion 120 is sized and dimensioned to be received within the pommel pocket 70. A pommel fastener 124 may be used to secure the pommel to the frame member 40. With the base portion secured within the pommel pocket 70, the example cover support portion 122 extends upward and rearward from the pommel pocket 70.

The example cover support portion 122 is sized, dimensioned, and shaped to engage the seat cover 44 to support the seat cover 44 in an ergonomic configuration. In particular, a perimeter edge of the seat cover 44 is inserted into the upper edge groove 64 and stretched tight such that a firm but resilient seating surface is formed. The cover support portion 122 of the pommel 42 engages the seat cover 44 to define a longitudinal ridge that is ergonomically designed to facilitate prolonged comfortable seating while paddling the watercraft 24. The seat cover 44 is or may be a fabric made of water resistant material. The fabric provides the desired firm but resilient seating surface. The fabric may also be made of a mesh that allows water to pass through the seat cover 44 to allow quick drying of the seat cover 44.

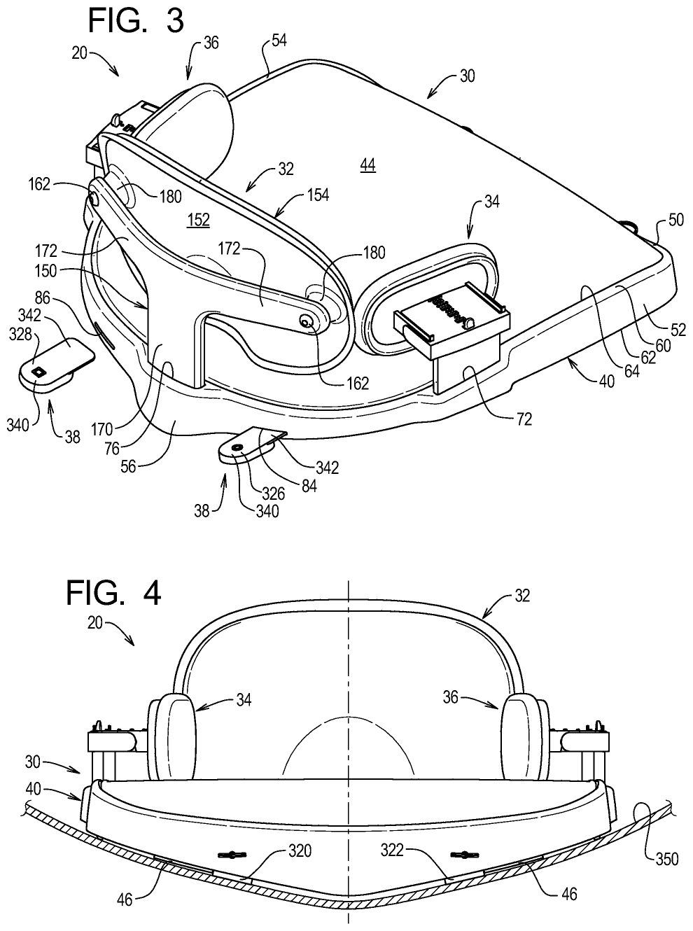

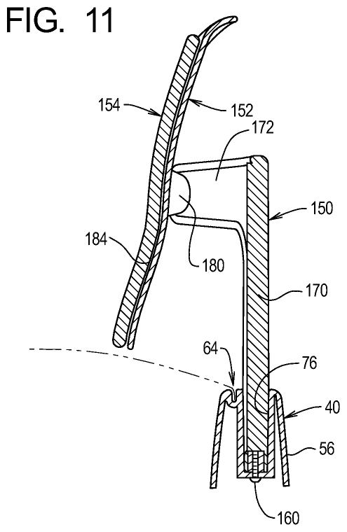

FIGS. 3 and 11 illustrate that the example back support assembly 32 comprises a T-support 150, a pad mounting member 152, and a back pad 154. The example T-support 150 is secured to the seat frame 40 with a frame fastener 160, and the back pad mounting member 152 is secured to the T-support using at least one pad fastener 162. The example T-support 150 defines an upright portion 170 and at least one lateral portion 172. The back pad mounting member 152 defines at least one main support projection 180 and a pad mounting surface 184.

The upright portion 170 of the example T-support 150 is sized and dimensioned to be received within the back pocket 76 of the seat frame 40. The example frame fastener 160 extends through the frame 40 and into the upright portion 170 to secure the T-support 150 to the frame 40. The example pad fasteners 162 extend through the lateral portion(s) 172 of the example T-support 150 and into the back pad mounting member 152 to secure the mounting member 152 relative to the T-support 150. The example main and lateral support projections 180 are resiliently deformable to allow flexing of the back pad mounting member 152 relative to the T-support 150. The back pad 154 is rigidly secured to the pad mounting surface 184 of the back pad mounting member 152 to support the back pad 154 in a desired orientation relative to the seat assembly 30.

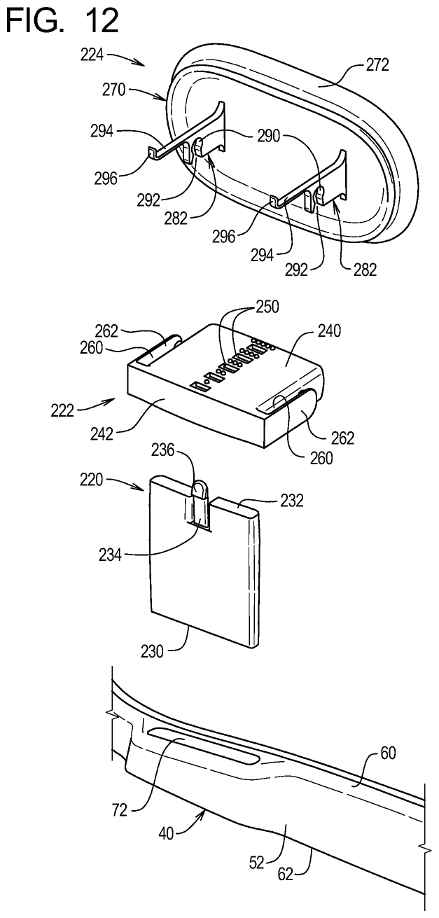

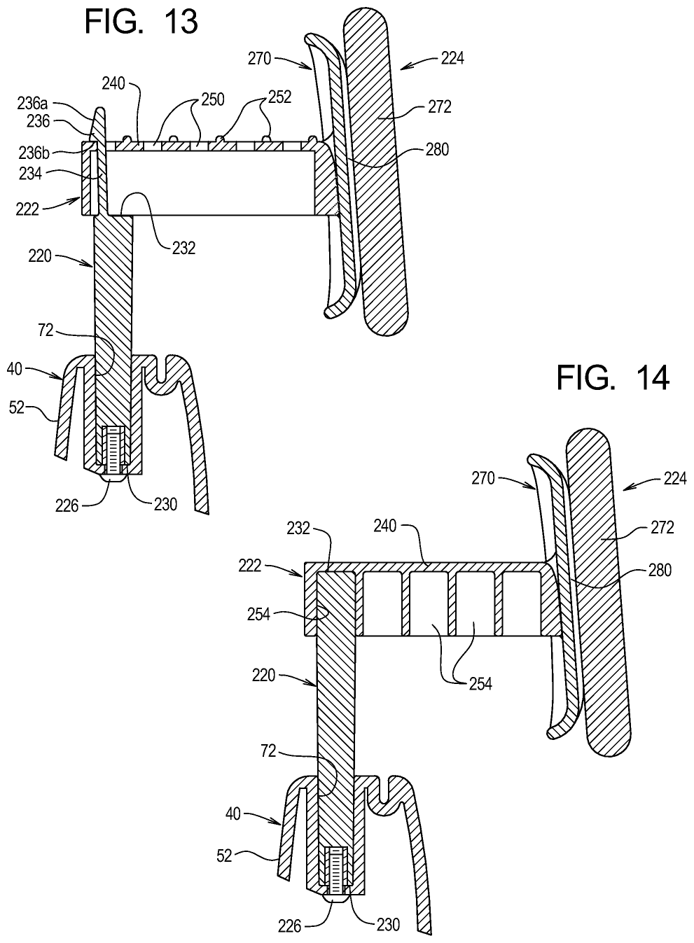

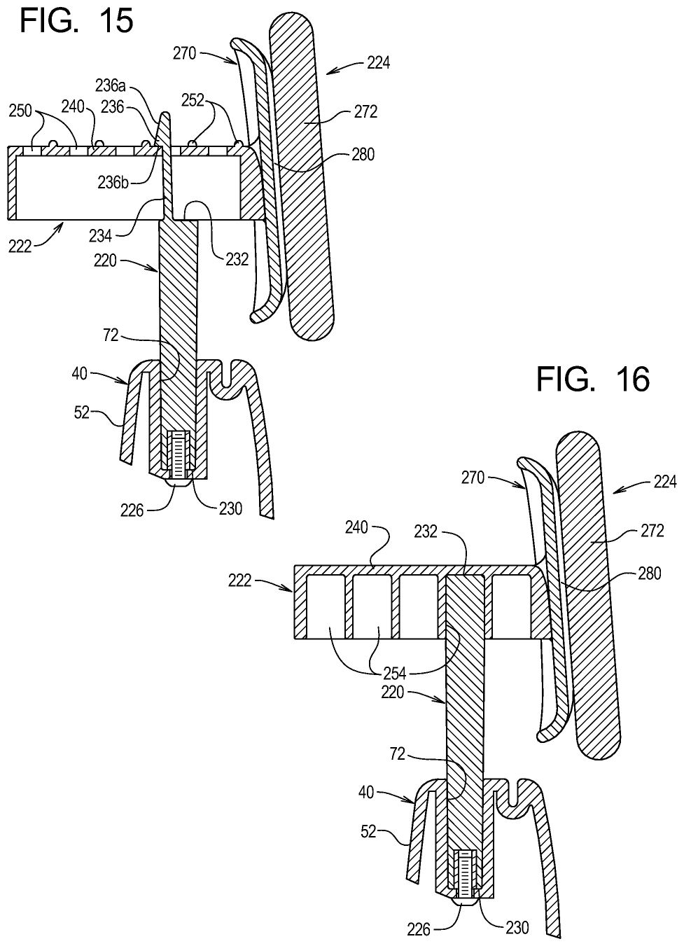

The example hip brace assemblies 34 and 36 are or may be the same, and only the first example hip brace assembly 34 will be described herein for clarity and brevity. FIGS. 12-18 illustrate that the example first hip brace assembly 34 comprises a hip upright 220, a hip lateral adjustment member 222, a hip pad 224, and a hip fastener 226.

The example hip upright 220 defines a lower end 230, an upper end 232, a detent tab 234, and a lock projection 236.

The example hip lateral adjustment member 222 defines a main wall 240 and a side wall 242. The example main wall 240 defines a plurality of lock openings 250, one or more indicator projections 252, and one or more support sockets 254. The example hip lateral adjustment member 222 further defines at least one side groove 260, at least one wing wall 262, at least one main support bridge 264, at least one upper retaining bridge 266, and at least one lower retaining bridge 268.

The example hip pad assembly 224 comprises a hip pad support member 270 and a hip pad 272. The example hip pad support member 270 defines a hip pad support surface 280 and at least one suspension arm 282. The hip pad 272 is secured to the hip pad support surface 280. The at least one suspension arm 282 defines a main support notch 290 having a restriction 292, an extension portion 294, and an extension hook 296.

FIGS. 13-16 illustrate that the example hip brace assemblies 34 and 36 allow lateral movement of the hip pad 272. In particular, the lower end 230 of the hip upright 220 is received within the hip pocket 72, and the hip fastener 226 is inserted through the seat frame 40 and threaded into the lower end 230 to secure the hip upright 220 in a substantially vertical orientation relative to the seat frame 40. At least a portion of the upper end 232 of the hip upright 220 is received within one of the support sockets 254 defined by the hip lateral adjustment member 222. Different hip sockets 254 are associated with different lateral positions as indicated by the indicator projections 252.

At the same time, a portion of the detent tab 234 extends through an associated lock opening 250 such that the lock projection 236 on the detent tab 234 engages the main wall 240 to inhibit vertical movement of the hip lateral adjustment member 222 relative to the hip upright 220. In particular, the example lock projection 236 is configured with a cam surface 236a and a lock surface 236b. The cam surface 236a engages the main wall 240 around the lock opening 250 to deform the detent tab 234 to allow the lock projection 236 to pass in one direction through the lock opening 250. The lock surface 236b then engages the main wall 240 to inhibit removal of the detent tab 234 from the lock opening 250. However, deliberate application of manual force on the detent tab 234 releases the lock surface 236b and allows the detent tab 234 to be removed from the lock opening 250. The lateral position of the hip brace assembly 34 will thus be determined by which support socket 254 receive the upper end 232 of the upright 220 and which lock opening 250 receives the detent tab 234.

The location of the detent tab 234 may be moved from the hip upright 220 to the hip lateral adjustment member 222 with similar effect. Further, the detent lock system formed by the detent tabs 234 and lock openings 250 may be eliminated, in which case friction and/or gravity may be used to secure the hip lateral adjustment member 222 in a desired lateral position relative to the hip upright 220. As another alternative to the sockets and detent tab, the adjustment member 222 may slide laterally on a rail supported by the hip upright through a continuum of positions from an innermost and outermost positions relative to the seat frame 40. A screw lock, detent lock, friction, or other type of system for securing the adjustment member relative to the hip upright may be used to secure the hip lateral adjustment member 222 at a desired location along the continuum of locations.

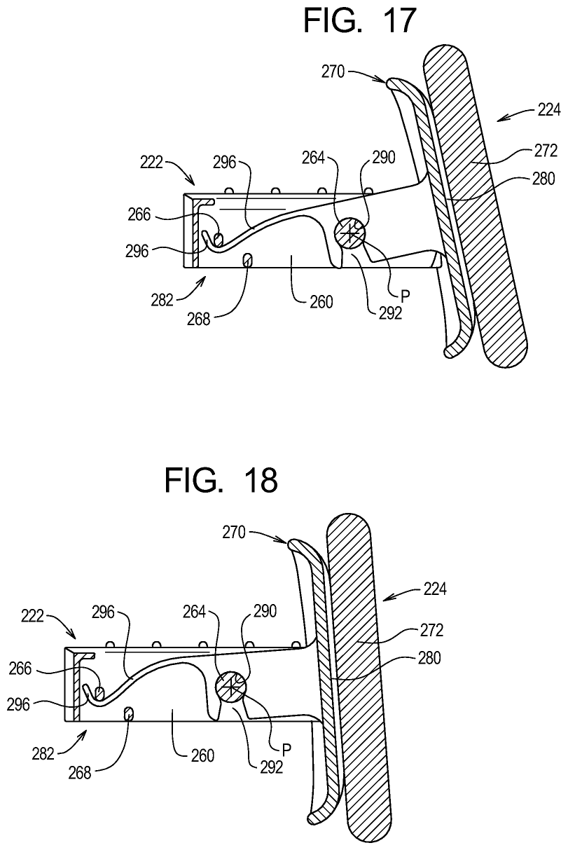

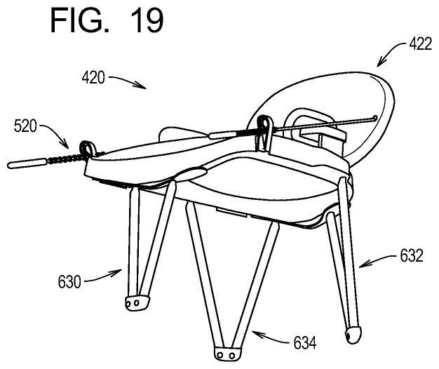

FIGS. 17 and 18 illustrate that the hip pad assembly 224 may further rock or pivot relative to the hip lateral adjustment member 222. In particular, the suspension arm(s) 282 of the hip pad support member 270 are resiliently deformable to allow movement of the hip pad about a pivot axis P. The main support notch 290 of the suspension arm(s) 282 receives the main support bridge 264 to detachably attach the hip pad support member 270 to the hip lateral adjustment member 222, with the restriction 292 inhibiting inadvertent removal of the main support bridge 264 from the main support notch 290. The extension portion 294 of the suspension arm(s) 282 is arranged over the lower retaining bridge 268 and below the upper retaining bridge 266 with the extension hook 296 extending at least partly around the upper retaining bridge 266. The suspension arm 282 is resiliently deformable to allow pivoting of the hip pad support member 270, and thus the hip pad 272 secured thereto, relative to the lateral adjustment member 222.

FIGS. 2-4 illustrate that the example cleat system 38 comprises first and second front cleats 320 and 322 and associated spring pin(s) 324 and first and second rear cleats 326 and 238. Each front cleats 320 and 322 defines a front cleat base 330 and a front cleat projection 332 defining a front cleat opening 334. Each of the rear cleats 326 and 238 defines a rear cleat base 340 and a rear cleat projection 342.

The front cleat base(s) 330 and rear cleat base(s) 340 are glued or otherwise rigidly secured to a support surface such as a surface 350 of the water craft 24 within the cockpit 22. With the example front cleat bases 330 secured to the cockpit surface 350, the front cleat projection(s) 332 extending substantially vertically and the front cleat opening 334 extending substantially horizontally. With the example rear cleat base(s) 340 secured to the cockpit surface 350, the rear cleat projection 342 extends substantially horizontally.

To secure the example seat system 20 within the cockpit 22 of the watercraft 24, the seat frame 40 is arranged such that the rear cleat projections 342 of the first and second rear cleats 326 and 238 are aligned with the first and second rear cleat pockets 84 and 86 defined by the seat frame 40. The seat frame 40 is then displaced rearward such that the rear cleat projections 342 enter the rear cleat pockets 84 and 86. At the same time, the seat frame 40 is pivoted up slightly such that the front cleat projections 332 do not interfere with rearward movement of the seat frame 40. When the rear cleat projections 342 are within the rear cleat pockets 84 and 86, the front portion 50 of the seat frame 40 is pivoted downward such that the front cleat projections 332 of the front cleats 322 and 320 enter the front cleat pockets 80 and 82. The spring pins 324 are then inserted through the pin openings 90 and 92 and into the pin openings 334 in the front cleat projections 332 to prevent the seat frame 40 from being pivoted such that the front cleat projections 332 are removed from the front cleat pockets 80 and 82. With the spring pins 324 in place, the example seat system 20 is secured in a desired relationship relative to the cockpit 22. If used, the foot members 46 are arranged within the foot pockets 88 to engage the cockpit surface 350 and thereby protect the cockpit surface 350 and, if resilient, inhibit transmission of shocks from the cockpit surface 350 to the seat system 20.

The example seat system 20 may be removed by removing the spring pins 324, tilting the seat frame 40 such that the front cleat projections are no longer within the front cleat pockets 80 and 82, and then sliding the seat frame 40 forward such that the rear cleat projections 342 are removed from the rear pockets 84 and 86. The seat system 20 may then lifted out of the cockpit 22.

Referring now to FIGS. 19-38, depicted therein is a second example seat system 420 constructed in accordance with, and embodying, the principles of the present invention. The second example seat system 420 is or may be similar to the first example seat system 20 and will be described herein only to that extent necessary to provide a complete understanding of the construction and operation of the present invention. In particular, the second example seat system 420 comprises a second example back support system 422 that allows vertical adjustment.

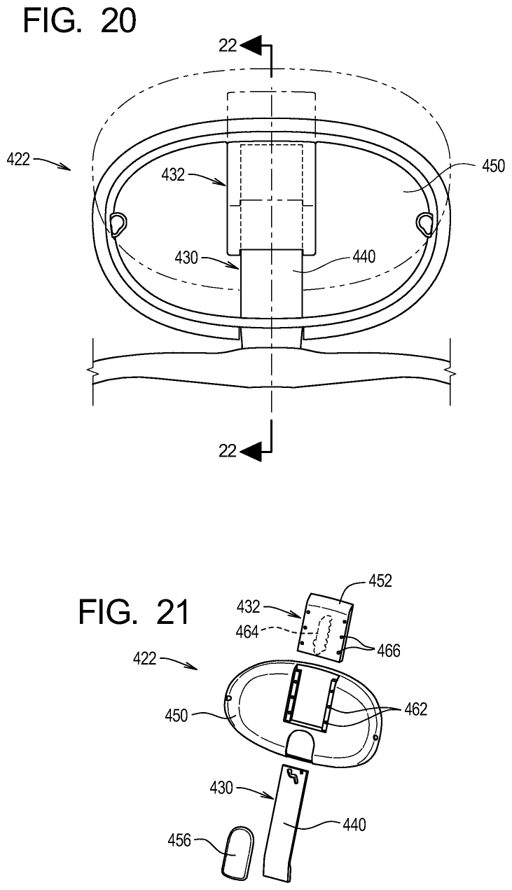

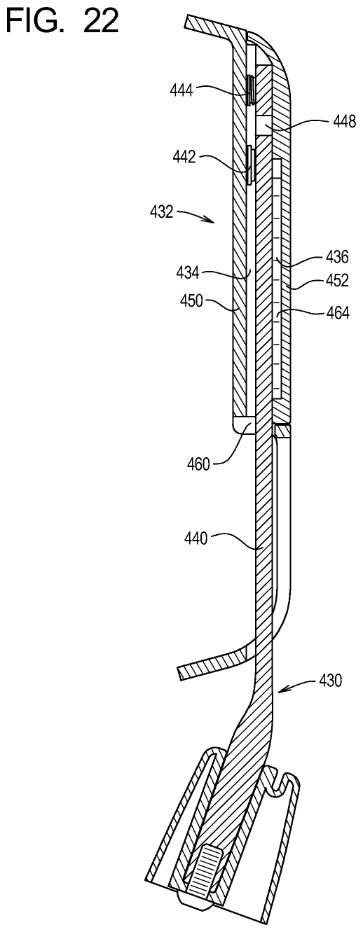

The second example back support system 422 comprises an upright assembly 430 and a back support assembly 432. The upright assembly 430 is fixed and, as shown in FIG. 20, the back support assembly 432 is supported by the upright assembly 430 for movement between lower (solid lines) and upper (broken lines) positions. As perhaps best shown in FIGS. 22 and 27, the upright assembly 430 and back support assembly 432 are arranged to define a rear chamber 434 and a front chamber 436.

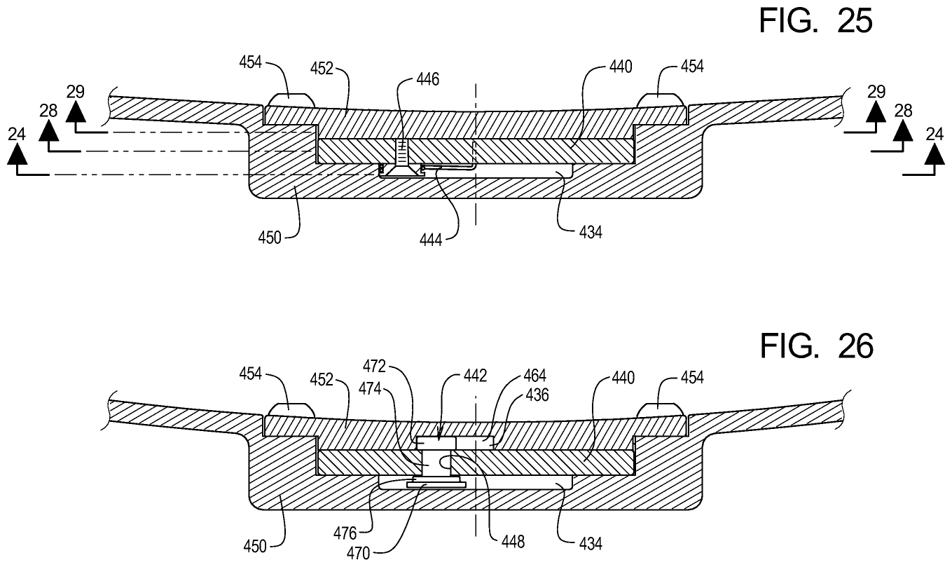

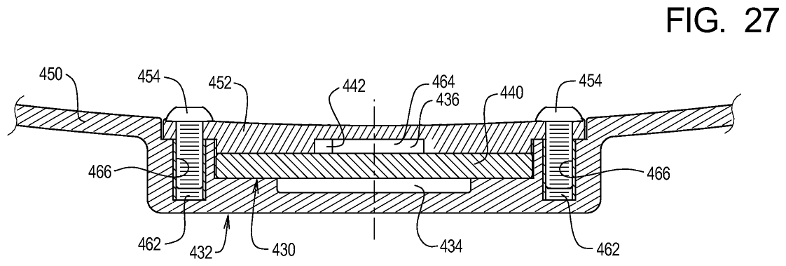

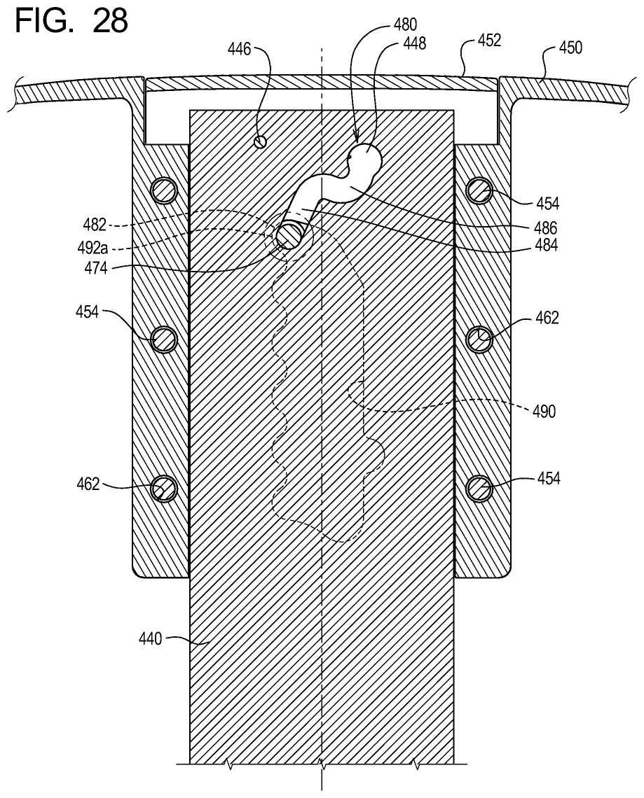

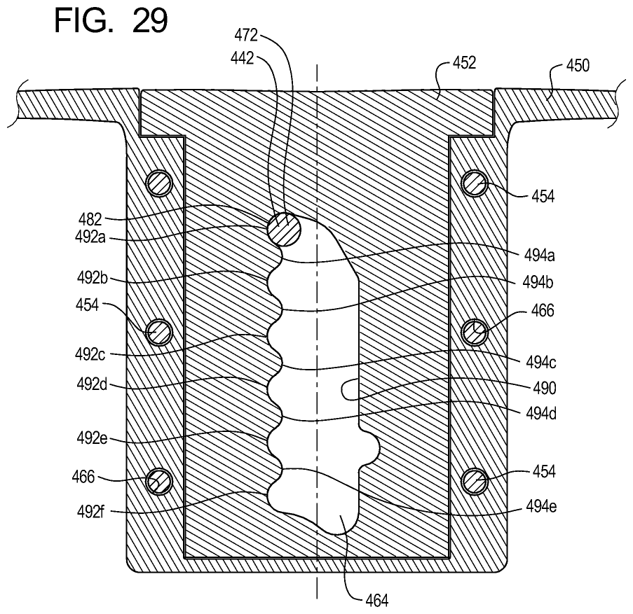

The example upright assembly 430 comprises an upright member 440, a guide member 442, a biasing member 444, and a biasing fastener 446. The example upright member 440 defines a guide slot 448. The example back support assembly 432 comprises a support plate 450, a guide plate 452, one or more support fasteners 454, and a back cushion 456. The example support plate 450 defines a support slot 460 and one or more fastener openings 462. The example guide plate 452 defines a guide cavity 464 and a plurality of fastener cavities 466. As perhaps best shown in FIG. 26, the example guide member 442 defines a rear portion 470, a front portion 472, an intermediate portion 474 extending between the rear and front portions 470 and 472, and an annular recess 476 formed between the rear portion 470 and the intermediate portion 474. Cross-sectional areas of the rear and front portions 470 and 472 are greater than a cross-sectional area of the intermediate portion 474. As perhaps best shown in FIG. 22, the front chamber 436 is defined by the upright member 440 and the guide cavity 464, while the rear chamber 434 is defined by the upright member 440 and a portion of the support plate 450.

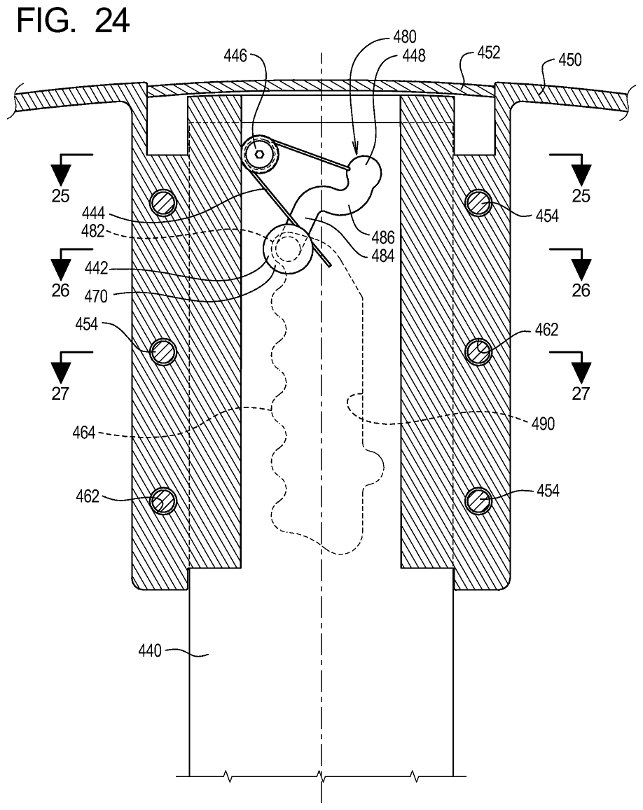

The example guide slot 448 defines a guide path 480 having first, second, third, and fourth portions 482, 484, 486, and 488 as shown in FIGS. 24, 28, 30A, 30B, 31, 32, 33A, 33B, 34A, 34B, 35A, 35B, 36A, 36B, 37A, 37B, and 38. The example guide cavity 464 defines a perimeter edge 490, and the perimeter edge 490 of the guide cavity 464 in turn defines one or more elevation notches 492a, 492b, 492c, 492d, 492e, and 492f, one or more elevation projections 494a, 494b, 494c, 494d, and 494e, a return portion 496, and an assembly notch 498.

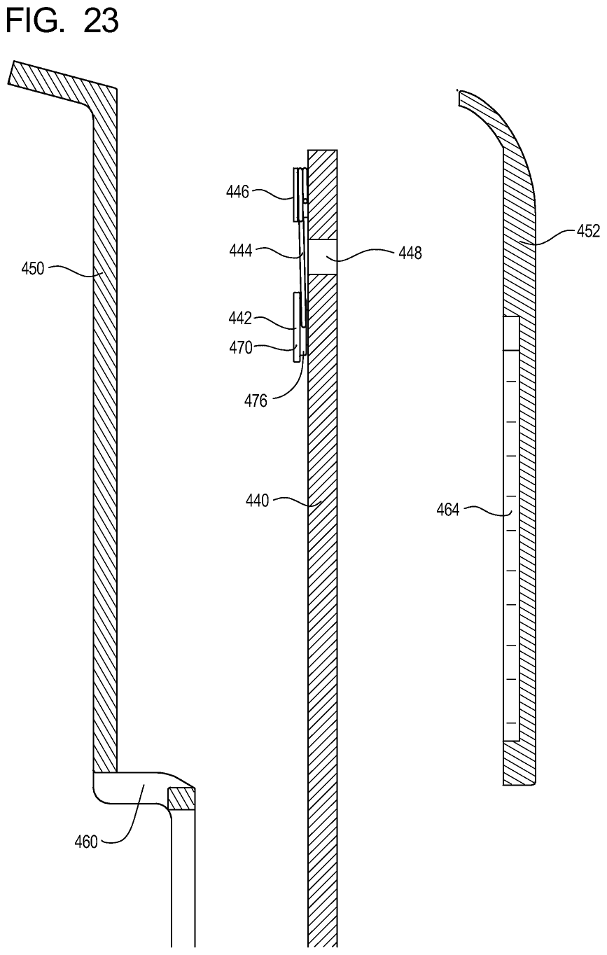

To assemble the example back support assembly onto the upright assembly 430, the upright member 440 is extended through the support slot 460 and arranged between a portion of the support plate 450 and the guide plate 452. As perhaps best shown in FIGS. 22, 24, 26, and 27, the support fasteners 454 extend through the fastener openings 462 and are threaded into the fastener cavities 466 to secure the guide plate 452 to the support plate 450 with a portion of the upright member 440 between a portion of the support plate 450 and the guide plate 452. Further, the guide member 442 is supported by the upright member 440 such that intermediate portion 474 is within the guide slot 448, the rear portion 470 of the guide member 442 is within the rear chamber 434, and the front portion 472 of the guide member 442 is within the front chamber 436 as shown in FIG. 26. The biasing fastener 446 secures the biasing member 444 to the upright member 440 such that biasing member 444 is in contact with the annular recess 476 in the guide member 442 as shown in FIGS. 23 and 24. As perhaps best illustrated in FIG. 24, example biasing member 444 is a coil spring configured to apply a generally downward and lateral (to the left in FIG. 24) biasing force on the guide member 442.

So assembled, the guide member 442 interacts with the guide slot 448 and the guide cavity 464 as shown in FIGS. 24-38 to limit movement of the back support assembly 432 relative to the upright assembly 430. In particular, each of the elevation notches 492 corresponds to a unique elevation of the support assembly 432 relative to the seat assembly 420. In particular, the intermediate portion 474 of the guide member 442 is biased by the biasing member 444 into the first portion 482 of the guide path 480 defined by the guide slot 448, as shown in FIGS. 24, 28, and 29, and the rear portion 472 of the guide member 442 is within the first elevation notch 492a defined by the perimeter edge 490 of the guide cavity 464 as shown in FIG. 29. In this configuration, the back support assembly 432 is held in its lowermost position against downward forces applied to the back support assembly 432.

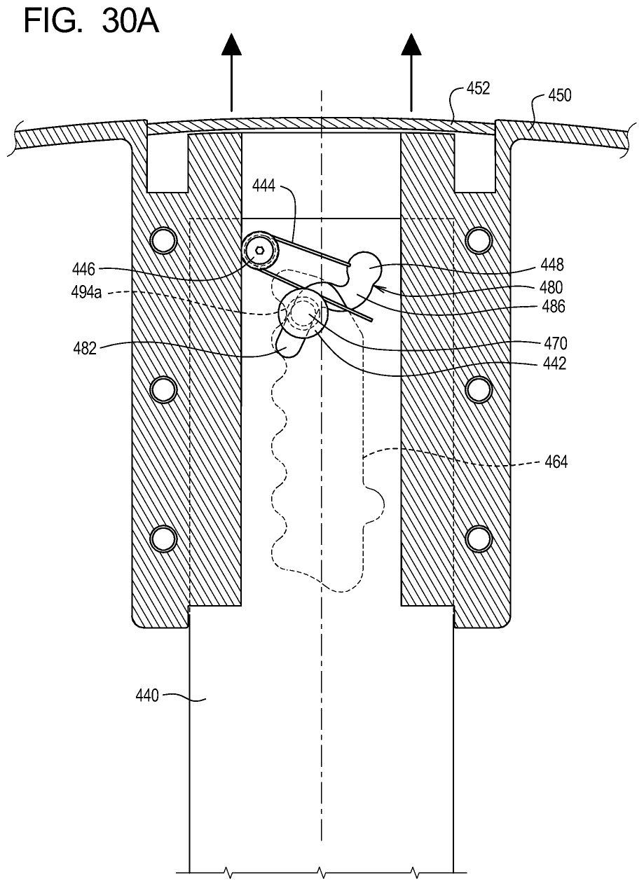

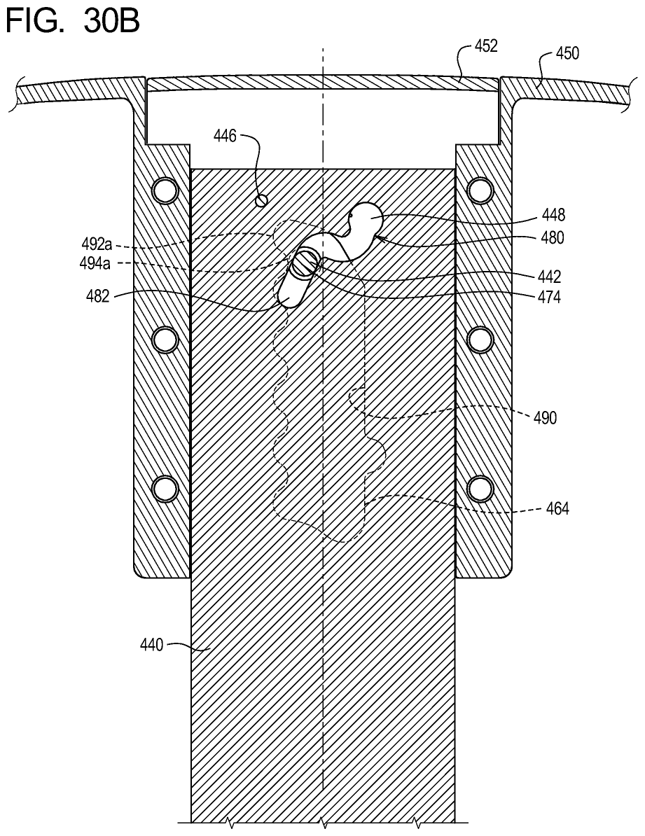

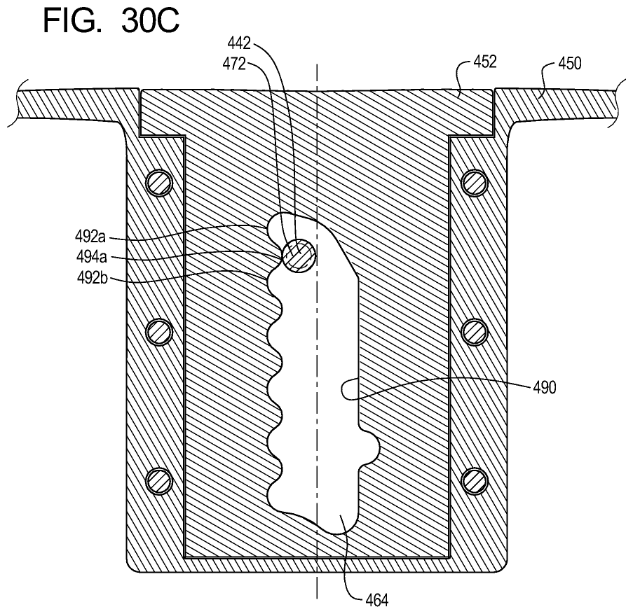

However, applying an upward lifting force on the back support assembly 432 as shown in FIG. 30A causes the first elevation projection 494a to displace the guide member 442 against the force of the biasing member 444, thereby allowing the guide member 442 to move over the first elevation projection 494a as shown in FIGS. 30B and 30C and eventually into the second elevation notch 492b defined by the perimeter edge 490 of the guide cavity 464. At the same time, the intermediate portion 474 of the guide member 442 moves out of the first portion 482 and into the second portion 484 of the guide path 480 defined by the guide slot 448. In this configuration, the back support assembly 432 is held in a first intermediate position defined by the second elevation notch 492b against downward forces applied to the back support assembly 432.

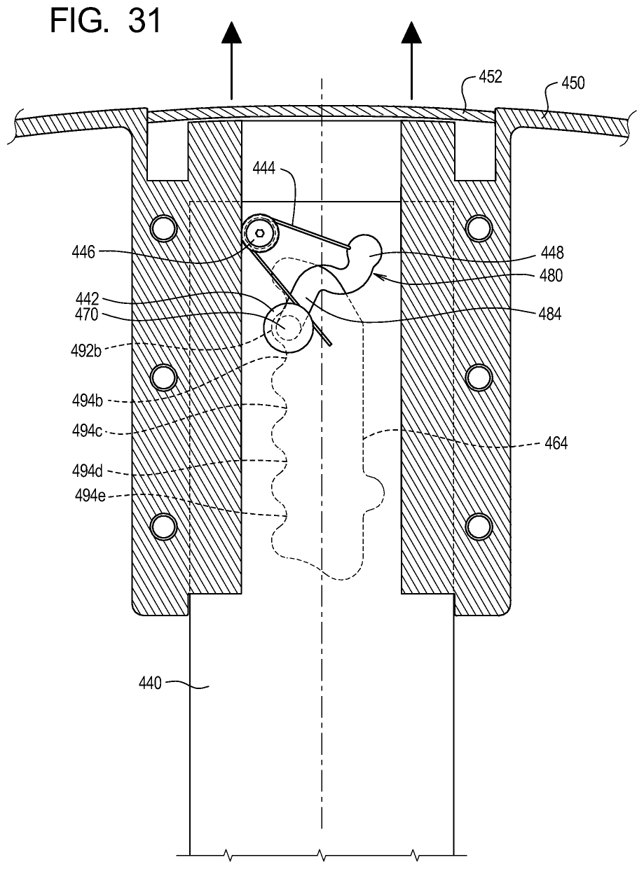

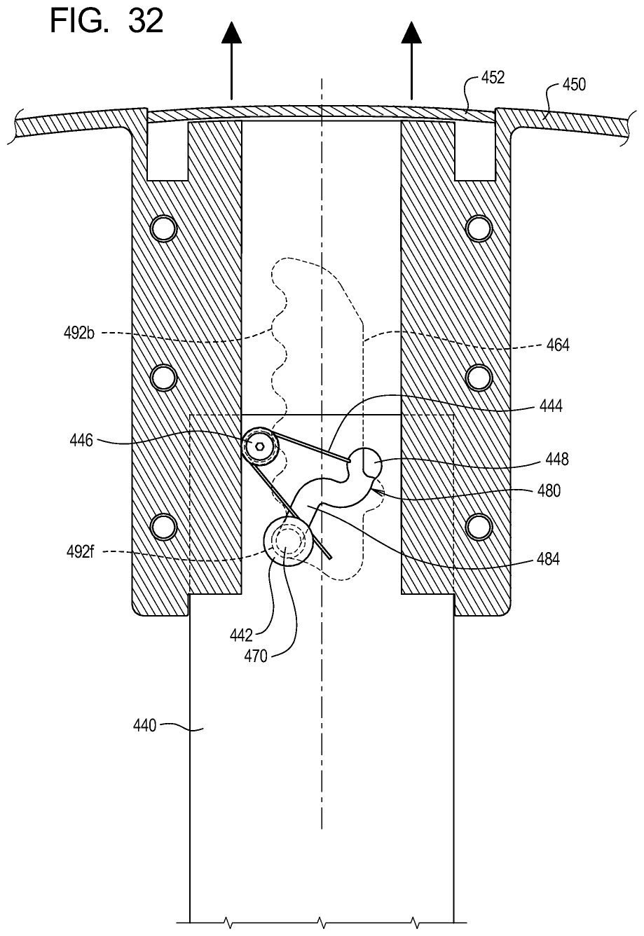

Continuing to apply a lifting force on the back support assembly 432 as shown in FIG. 31 causes successive elevation projections 494b-e to displace the guide member 442 against the force of the biasing member 444, thereby allowing the guide member 442 to move over the elevation projections 494b-e until the guide member 442 reaches the sixth elevation notch 492f as shown in FIG. 32. Again, the intermediate portion 474 of the guide member 442 moves out of the first portion 482 and into the second portion 484 of the guide path 480 defined by the guide slot 448 each time the guide member 442 traverses over one of the elevation projections 494. In the configuration shown in FIG. 32, the back support assembly 432 is held in an uppermost position defined by the sixth elevation notch 492f against downward forces applied to the back support assembly 432.

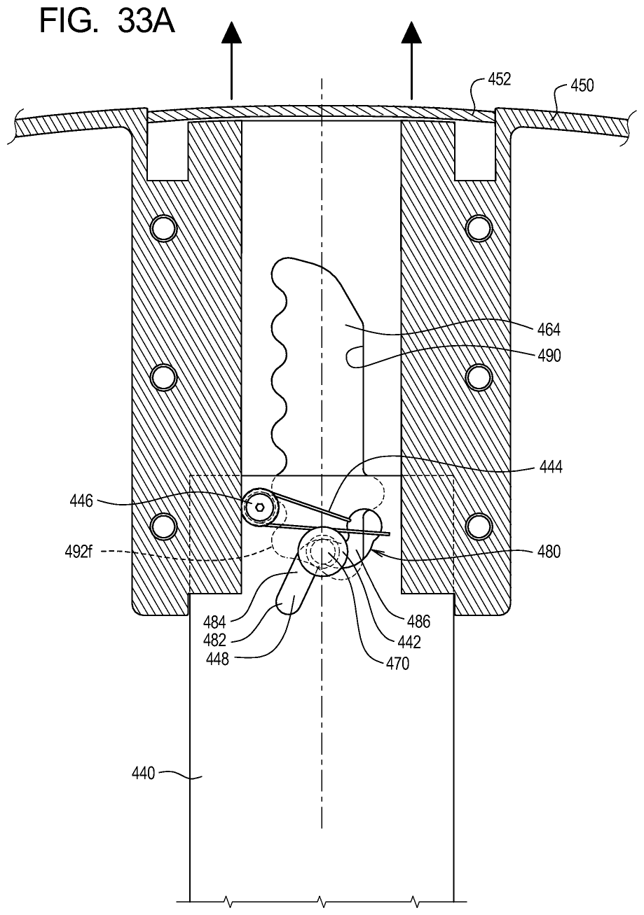

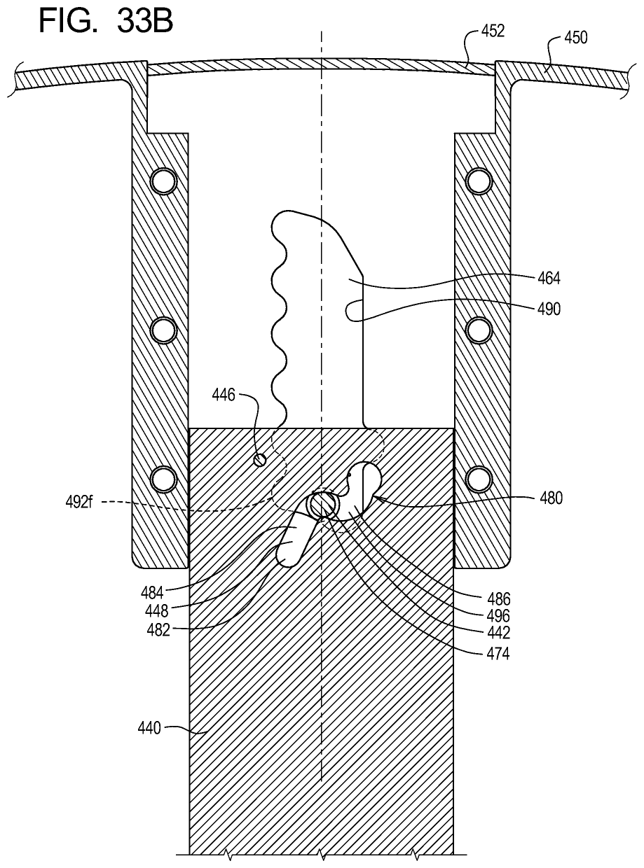

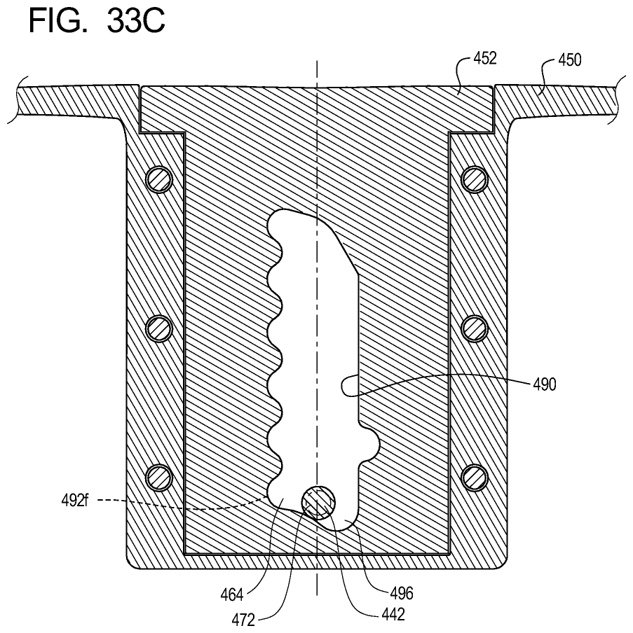

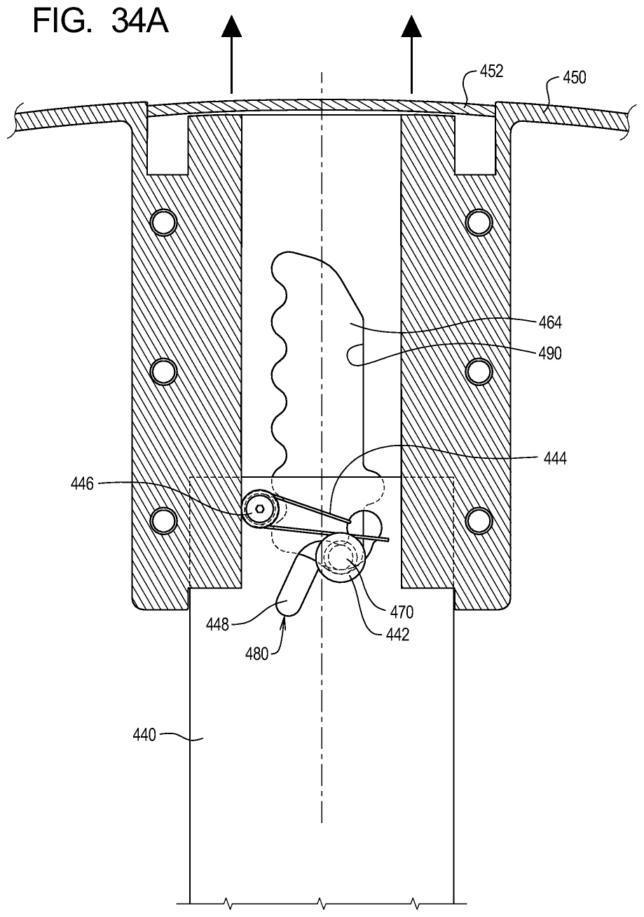

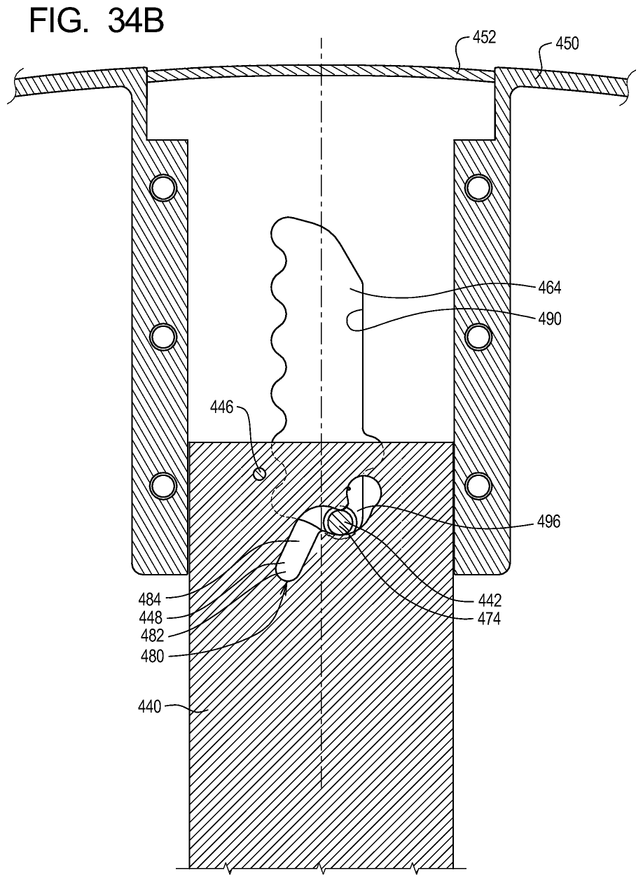

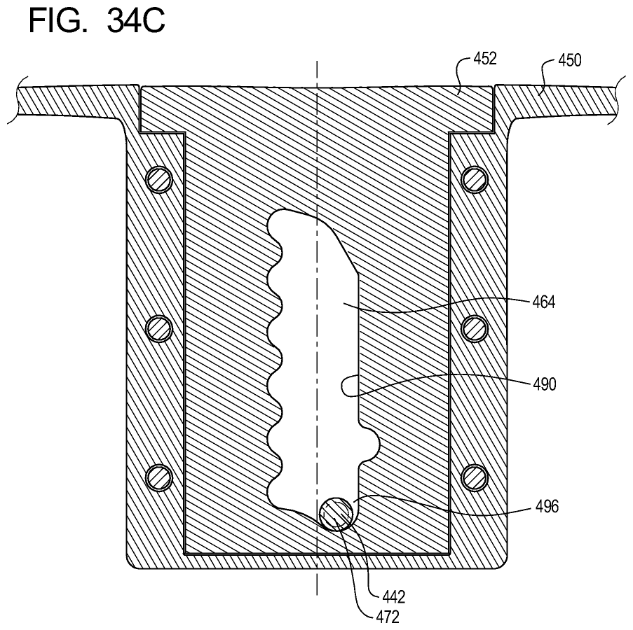

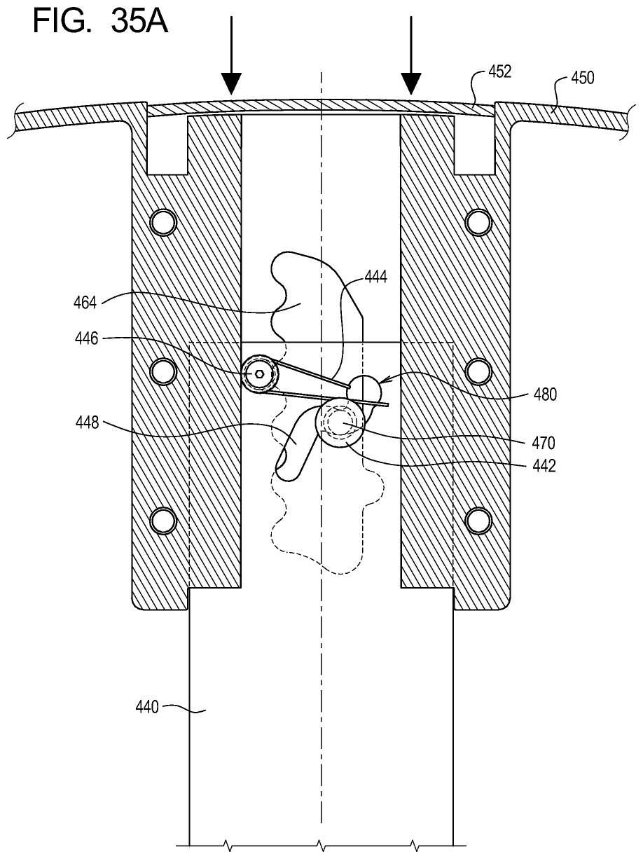

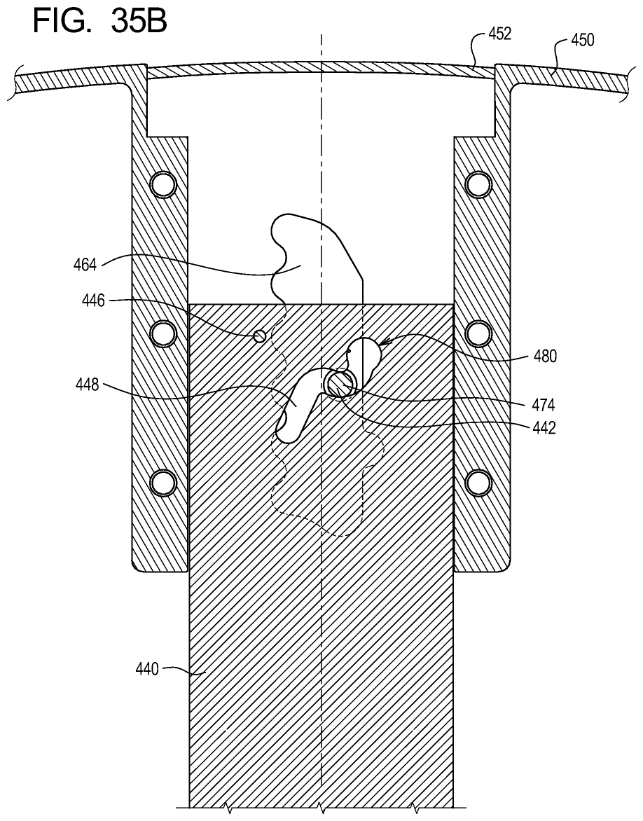

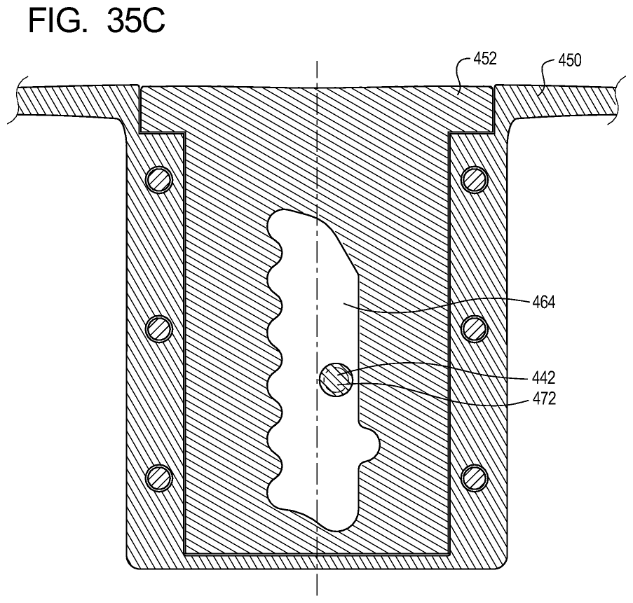

As shown in FIGS. 33A, 33B, 33C and 34A, 34B, and 34C, applying an additional lifting force on the back support assembly 432 causes the guide member 442 to move out of the sixth elevation notch 492f and into the return portion defined by the perimeter edge 490 of the guide cavity 464. In particular, the intermediate portion 474 of the guide member 442 moves from the first portion 482 of the guide slot 448, through the second portion 484 of the guide slot 448, and into the third portion 486 of the guide slot 448. The shape of the guide slot 448 between the second and third portions 484 and 486 holds the intermediate portion 474 in the third portion 486 against the force of the biasing member 444 as shown in FIGS. 35A, 35B, and 35C so that the guide member 442 does not engage any of the elevation notches 492 or elevation projections 494, thereby allowing the back support assembly 432 to be moved towards the lowermost position.

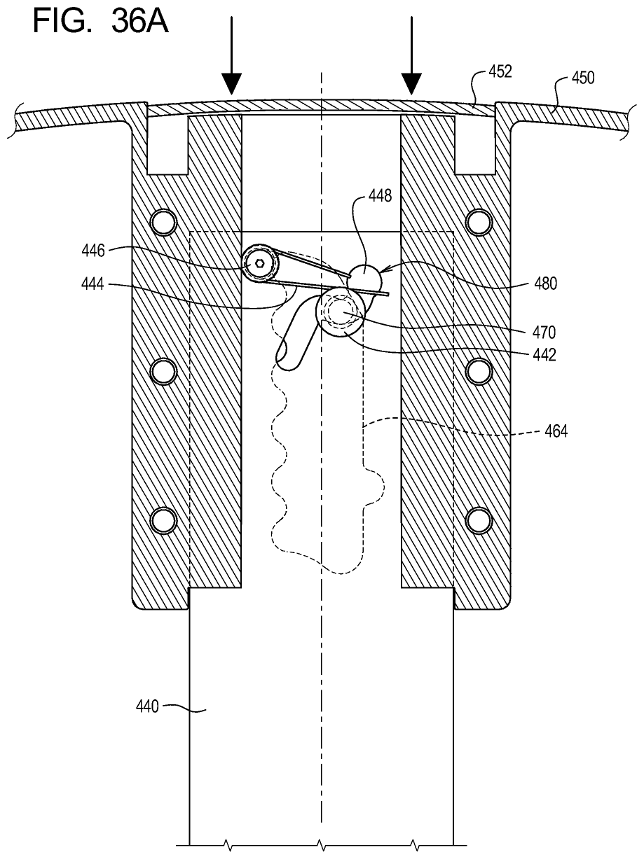

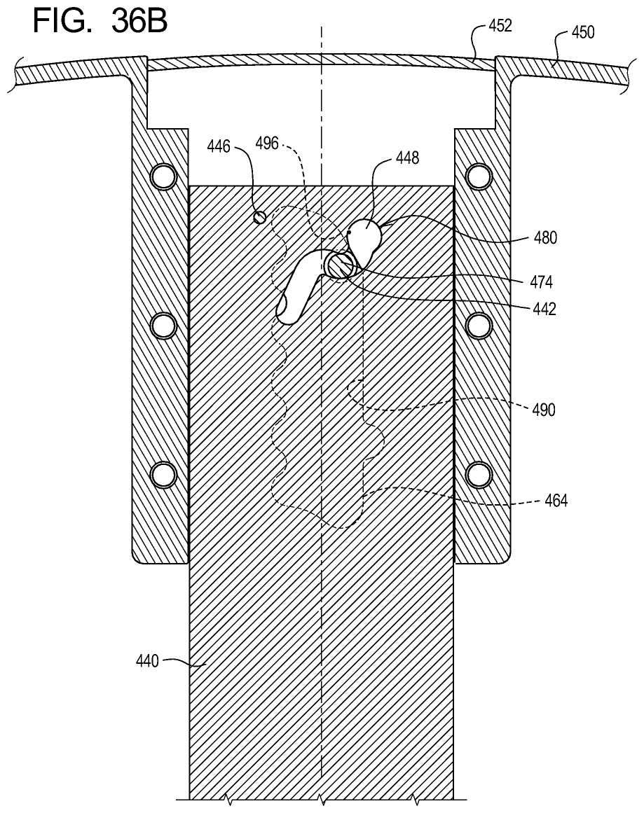

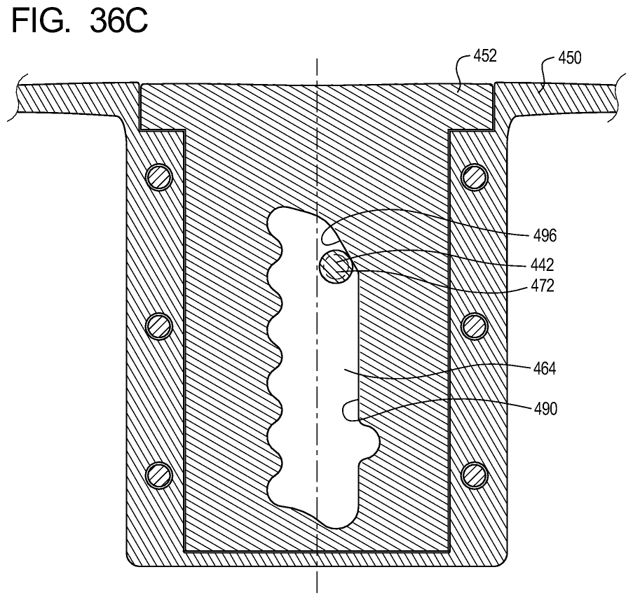

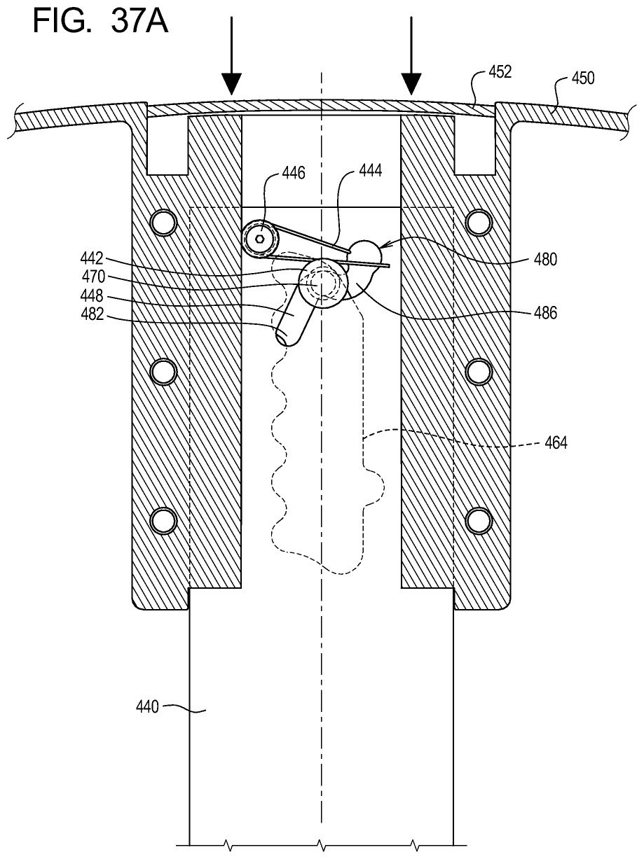

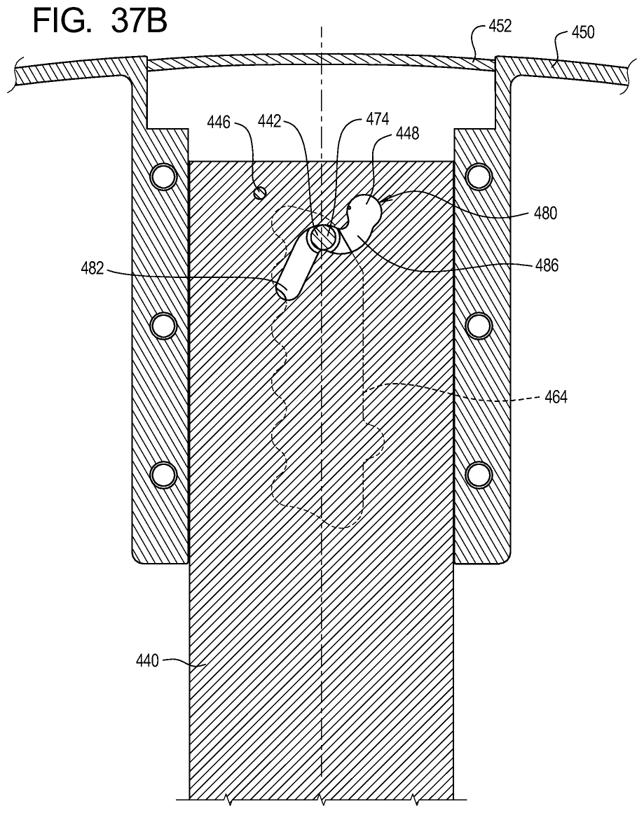

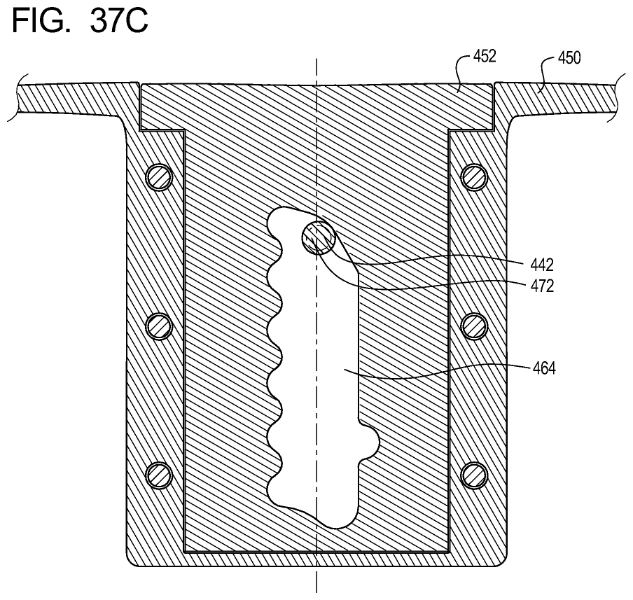

As shown in FIGS. 36A, 36B, and 36C, the guide member 442 eventually comes into contact with the return portion 496 of the perimeter edge 490. With continued downward movement of the back support assembly 432 relative to the upright assembly 430, the return portion 496 engages the guide member 442 to displace intermediate portion 474 of the guide member 442 out of third portion 486 as shown in FIGS. 37A, 37b, and 37C and back into the first portion 482 of the guide path 480 as shown in FIG. 38. The back support assembly 432 is returned to and locked in its lowermost position. This process may be repeated until the back support assembly 432 is locked in a desired vertical orientation relative to the seat assembly 420 for a particular set of operating conditions.

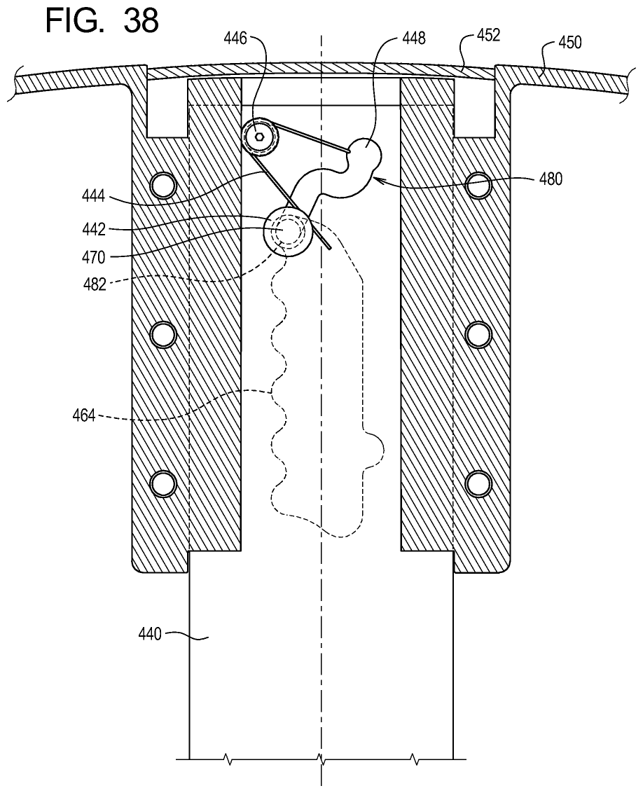

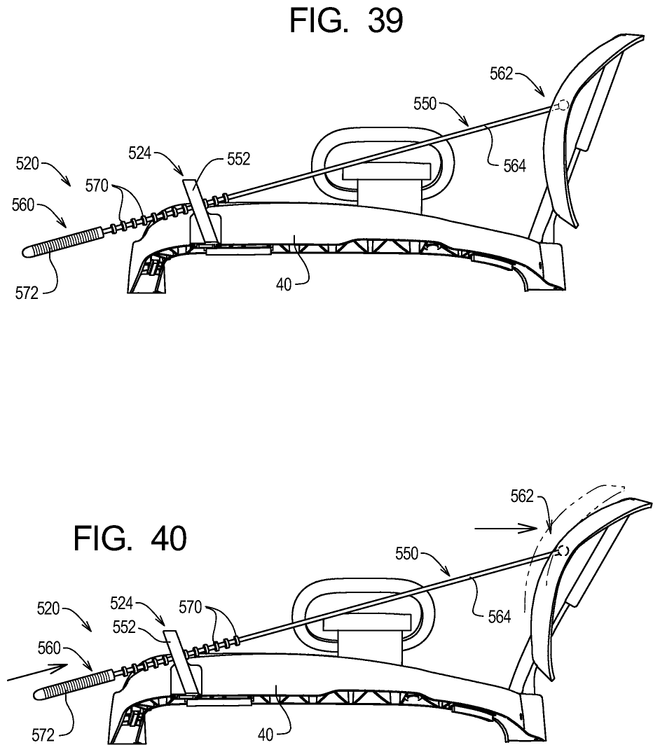

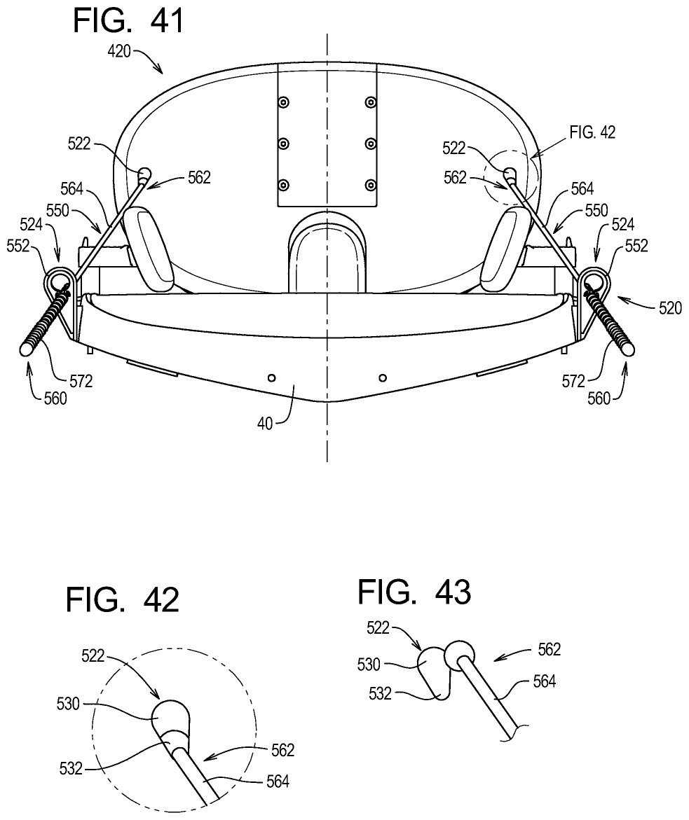

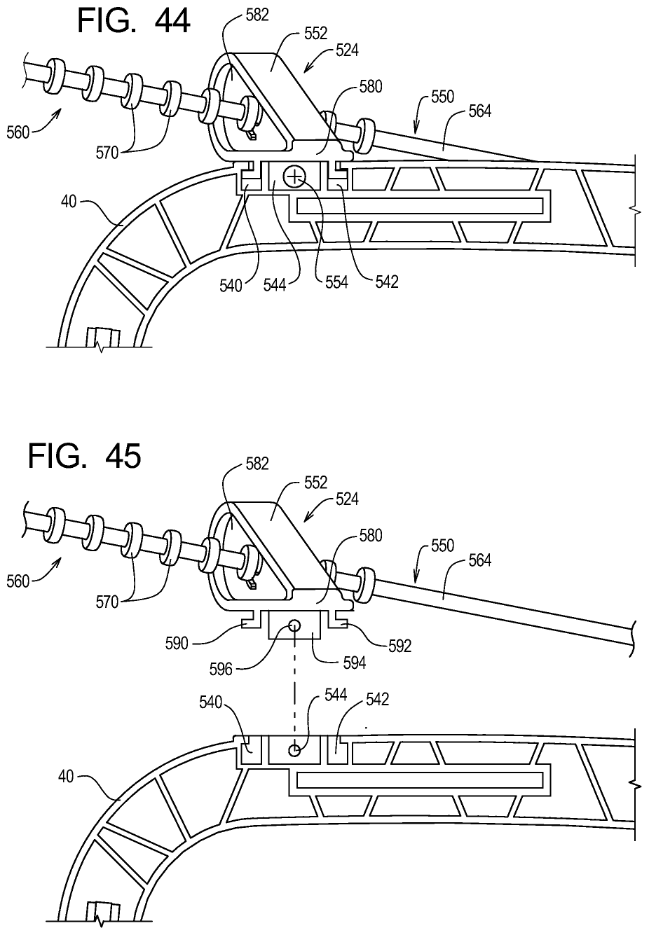

Depicted in FIGS. 39-51 is a strap system 520 adapted to extend between one or more back openings 522 formed in the second example seat system 420 and one or more anchor structures 524 defined by the frame 40 of the seat assembly 30. As perhaps best shown in FIGS. 42 and 43, the example back openings 522 define an upper portion 530 and a lower portion 532. A cross-sectional area of the upper portion 530 is larger than a cross-sectional area of the lower portion 532. FIGS. 44 and 45 illustrate that the example anchor structures 524 defined by the frame 40 comprise a first lateral slot 540, a second lateral slot 542, and an anchor fastener cavity 544.

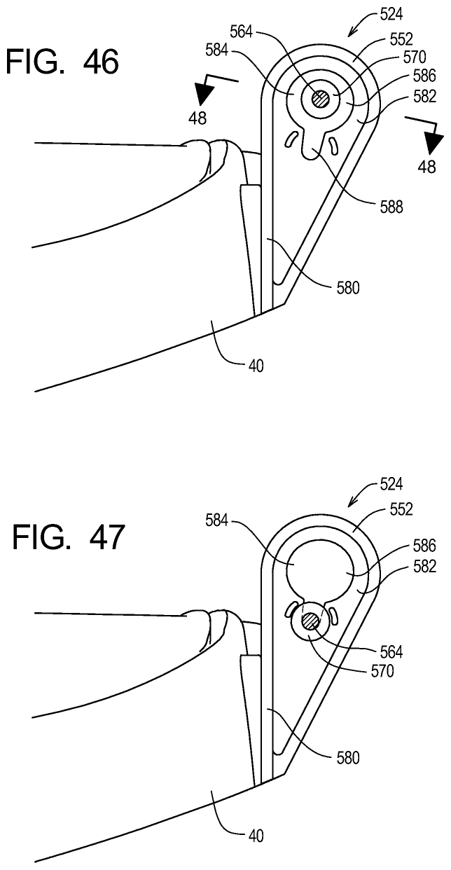

FIGS. 39-41 illustrate that the example strap system 520 comprises one or more support straps 550, one or more support anchors 552, and a strap anchor fastener 554. The example anchor straps 550 each comprise an anchor engaging portion 560, a back engaging portion 562, and a tension member 564 extending between the anchor engaging portion 560 and the back engaging portion 562. The example anchor engaging portion 560 comprises one or more anchor blocks 570 supported by the tension member 564 and a handle portion 572. FIGS. 44-47 illustrate that the example support anchors 552 comprise an anchor base 580 and an anchor extension 582 defining an anchor opening 584. As perhaps best shown in FIG. 46, the example anchor opening 584 defines an upper portion 586 and a lower portion 588. A cross-sectional area of the upper portion 586 is larger than a cross-sectional area of the lower portion 588. Each of the anchor bases 580 comprises a first leg 590, a second leg 592, and an anchor tab 594 defining an anchor fastener opening 596.

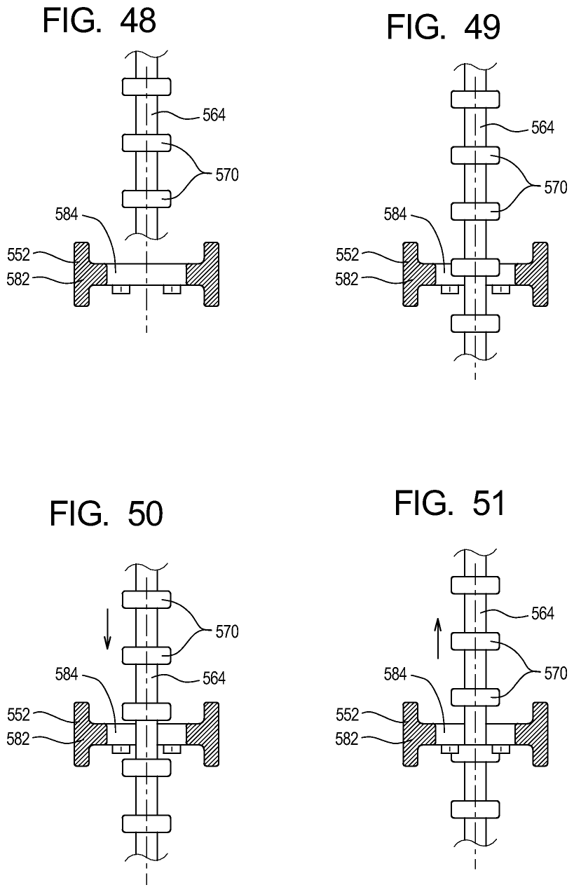

In use, the support anchors 552 are initially secured to the seat frame 40 as shown in FIGS. 44 and 45 by arranging the first and second legs 590 and 592 within the first and second lateral slots 540 and 542, inserting the strap anchor fastener 554 through the anchor fastener opening 596, and threading the strap anchor fastener 554 into the anchor fastener cavity 544. At this point, the anchor extension 582 extends laterally from the seat frame 40 as shown in FIGS. 46 and 47. Next, the back engaging portion 562 is displaced through the upper portion 530 of one of the back openings 522 and then displaced downward such that the lower portion 532 of the seat opening 522 inhibit withdrawal of the back engaging portion 562 from the seat opening 522 during normal use of the seat system 420. The handle portion 572 of the anchor engaging portion 560 is next displaced, as shown in FIGS. 46 and 47, through the upper portion 586 of the anchor opening 584 and then down such that the tension portion 564 of the support strap 550 is within the lower portion 588 and a selected one of the anchor blocks 570 engages the anchor extension 582 to inhibit withdrawal of the anchor engaging portion 560 from the anchor opening 584 during normal use of the seat system 420. FIGS. 48-51 illustrate that the selected one of the anchor blocks 570 decreases or increases an effective length of the tension member 564 applies, through the tension member 564, an appropriate amount of tension between the back support assembly 432 and the seat system 420 as required by a particular user.

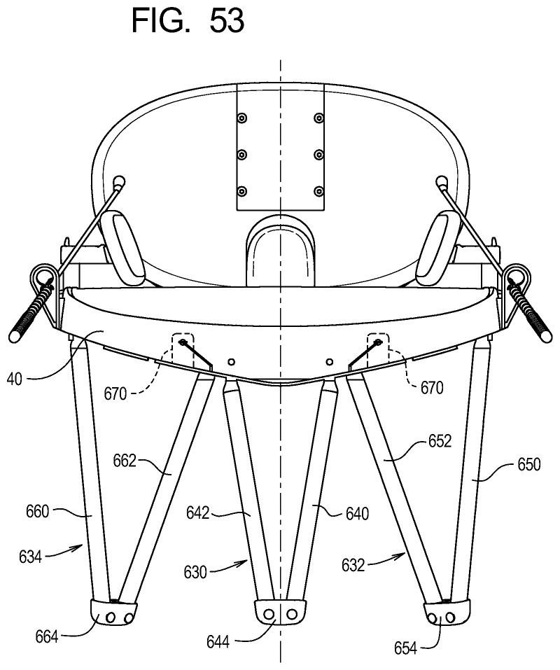

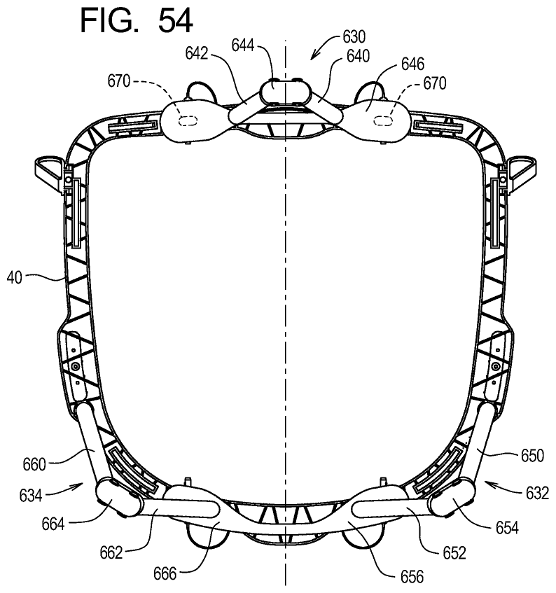

FIGS. 52 and 53 illustrate that either of the first and second example seat systems 20 and 420 can be used with a leg system 620 to form a conventional chair for use on a surface outside of the cockpit 22 of the kayak 24. The example leg system 620 comprises a front leg assembly 630, a first rear/side leg assembly 632, and a second rear/side leg assembly 634.

The front leg assembly 630 comprises a first leg portion 640, a second leg portion 642, a foot member 644, and a leg support plate 646. Upper ends of the first and second leg portions 640 and 642 engage the seat frame 40, and the foot member 644 joins the first and second leg portions 640 and 642 and engages the surface on which the seat system 20 or 420 is to be supported.

The first side/rear leg assembly 632 comprises a first leg portion 650, a second leg portion 652, a foot member 654, and a leg support plate 656. Upper ends of the first and second leg portions 650 and 652 engage the seat frame 40 through at least a portion of the leg support plate 656, and the foot member 654 joins the first and second leg portions 650 and 652 and engages the surface on which the seat system 20 or 520 is to be supported.

The second side/rear leg assembly 632 comprises a first leg portion 660, a second leg portion 662, a foot member 664, and a leg support plate 666. Upper ends of the first and second leg portions 660 and 662 engage the seat frame 40 through at least a portion of the leg support plate 666, and the foot member 664 joins the first and second leg portions 660 and 662 and engages the surface on which the seat system 20 or 520 is to be supported.

Upper ends of the example leg portions forming the leg system 620 can be received in sockets 670 formed in the seat frame 40 as shown in FIGS. 53 and 54 or may be permanently connected to the seat frame 40 with a hinge system (not shown) that allows the leg system 620 to be folded underneath the seat system 30 when the leg system 620 is not in use.

What is claimed is:

1. A seat system for a watercraft defining a support surface comprising:
a seat frame;
a seat cover supported by the seat frame;
at least one first mounting assembly; and
at least one second mounting assembly; wherein
the at least one first mounting assembly is secured to the support surface;
the at least one second mounting assembly is secured to the support surface;
the seat frame is slid horizontally to engage one of the first mounting assemblies; and
the seat frame is pivoted such that the seat frame moves downward to engage the second mounting assembly.

2. A seat system as recited in claim 1, further comprising:
a back assembly supported by the seat frame; and
first and second hip assemblies supported by the seat frame.

3. A seat system as recited in claim 2, in which at least one of the first and second hip assemblies is laterally adjustable relative to the seat frame.

4. A seat system as recited in claim 3, in which at least one of the first and second hip assemblies comprises:
an upright member supported by the seat frame;
a lateral adjustment member supported by the seat frame for movement between first and second lateral positions relative to the seat frame.

5. A seat system as recited in claim 4, in which:
the lateral adjustment member defines a plurality of lock openings; and
the upright member defines a detent tab that extends at least partly through one of the plurality of lock openings to secure the lateral adjustment member in a desired lateral position relative to the upright member.

6. A seat system as recited in claim 4, in which:
the lateral adjustment member defines a plurality of sockets; and
at least a portion of an upper end of the upright member extends at least partly into one of the plurality of sockets to support the lateral adjustment member in a desired lateral position relative to the upright member.

7. A seat system as recited in claim 4, in which:
the lateral adjustment member defines a plurality of sockets, and
a plurality of lock openings; and
the upright member defines
a plurality of sockets sized and dimensioned to receive at least a portion of an upper end of the upright member, and
a detent tab adapted to extend at least partly through one of the plurality of lock openings; wherein
when at least a portion of an upper end of the upright member extends at least partly into one of the plurality of sockets,
the lateral adjustment member is supported in a desired lateral position relative to the upright member, and
the detent tab extends at least partly through one of the plurality of lock openings to secure the lateral adjustment member in a desired lateral position relative to the upright member.

8. A seat system as recited in claim 4, further comprising a hip pad assembly comprising:
a hip pad; and
a hip pad support member; wherein
the hip pad support member supports the hip pad; and
the lateral adjustment member supports the hip pad support member for pivoting movement of the hip pad support member relative to the lateral adjustment member.

9. A seat system as recited in claim 8, in which the hip pad support member comprises comprising at least one suspension arm, where the suspension arm engages the lateral adjustment member to limit pivoting of the hip pad support member relative to the lateral adjustment member.

10. A seat system as recited in claim 1, further comprising a pommel supported by the seat frame, where the seat cover is supported by the seat frame and the pommel.

11. A seat system as recited in claim 10, in which the seat cover is made of flexible material.

12. A seat system as recited in claim 11, in which the seat cover is a mesh material.

13. A seat system as recited in claim 1, further comprising a back support comprising:
an upright assembly supported by the seat frame; and
a back support assembly supported by the upright assembly for movement relative to the seat frame; and
a guide member supported to engage the upright assembly and the back support assembly such that the guide member supports the back support assembly in at least upper and lower vertical positions relative to the upright assembly.

14. A seat system as recited in claim 13, in which:
the upright assembly defines a guide slot;
back support assembly defines a guide cavity; and
the guide member engages the guide slot and the guide cavity to lock a position of the back support assembly in either of the upper and lower vertical positions.

15. A seat system as recited in claim 14, in which:
the guide slot defines a guide path; and
the guide cavity defines a perimeter edge; wherein
the guide path and the perimeter edge are sized and dimensioned relative to each other such that the guide member engages the guide slot and the guide cavity such that
the back support assembly moves up and down relative to the upright assembly;
a position of the back support assembly is held in either of the upper and lower vertical positions.

16. A seat system as recited in claim 15, in which the guide member engages the upright assembly and the back support assembly such that the guide member supports the back support assembly in at least one intermediate vertical position between the upper and lower vertical positions.

17. A seat system for a watercraft defining a support surface comprising:
a seat frame;
a seat cover supported by the seat frame;
a mounting assembly for securing the seat frame to the support surface; and
first and second hip assemblies supported by the seat frame, where at least one of the first and second hip assemblies is laterally adjustable relative to the seat frame.

18. A seat system as recited in claim 17, in which at least one of the first and second hip assemblies comprises:
an upright member supported by the seat frame;
a lateral adjustment member supported by the seat frame for movement between first and second lateral positions relative to the seat frame.

19. A seat system as recited in claim 18, in which:
the lateral adjustment member defines a plurality of lock openings; and
the upright member defines a detent tab that extends at least partly through one of the plurality of lock openings to secure the lateral adjustment member in a desired lateral position relative to the upright member.

20. A seat system as recited in claim 18, in which:
the lateral adjustment member defines a plurality of sockets; and
at least a portion of an upper end of the upright member extends at least partly into one of the plurality of sockets to support the lateral adjustment member in a desired lateral position relative to the upright member.

21. A seat system for a watercraft defining a support surface comprising:
a seat frame;
a seat cover supported by the seat frame;
a mounting assembly for securing the seat frame to the support surface; and
a back support comprising:
an upright assembly supported by the seat frame,
a back support assembly supported by the upright assembly for movement relative to the seat frame, and
a guide member supported to engage the upright assembly and the back support assembly such that the guide member supports the back support assembly in at least upper and lower vertical positions relative to the upright assembly.

22. A seat system as recited in claim 21, in which:
the upright assembly defines a guide slot;
back support assembly defines a guide cavity; and
the guide member engages the guide slot and the guide cavity to lock a position of the back support assembly in either of the upper and lower vertical positions.

23. A seat system as recited in claim 22, in which:
the guide slot defines a guide path; and
the guide cavity defines a perimeter edge; wherein
the guide path and the perimeter edge are sized and dimensioned relative to each other such that the guide member engages the guide slot and the guide cavity such that
the back support assembly moves up and down relative to the upright assembly;
a position of the back support assembly is held in either of the upper and lower vertical positions.

24. A seat system as recited in claim 23, in which the guide member engages the upright assembly and the back support assembly such that the guide member supports the back support assembly in at least one intermediate vertical position between the upper and lower vertical positions.
